(19) United States
(12) Patent Application Publication
(10) Pub. No.: US 2007/0216290 A1
(43) Pub. Date: Sep. 20, 2007

(54) Organic EL light emitting display device

(76) Inventors: Genshiro Kawachi, Chiba (JP); Toshihiro Sato, Mobara (JP); Masaaki Okunaka, Mobara (JP); Noaki Tokuda, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/798,527

(22) Filed: May 15, 2007

Related U.S. Application Data
(63) Continuation of application No. 10/867,653, filed on Jun. 16, 2004.

(30) Foreign Application Priority Data
Jun. 16, 2003 (JP) 2003-170228

(51) Int. Cl. H01J 1/62

(52) U.S. Cl. 313/504

(57) ABSTRACT

An organic EL light emitting display device is provided which includes a matrix array having a plurality of pixel circuits, each including an organic light emitting element. A scan driving circuit and a current supply circuit are coupled to the pixel circuits. In addition, a plurality of pads are provided which are adapted to connect the scan driving circuit and the current supply circuit to external circuits. In accordance with one embodiment, the pads are located to be closer to the current supply circuit than to the scan driving circuit.

### CROSS-REFERENCE TO RELATED APPLICATIONS

This application is a continuation of U.S. application Ser. No. 10/867,653, filed Jun. 16, 2004; and which application claims priority from Japanese application JP2003-170228, filed on Jun. 16, 2003, the entire contents of which are hereby incorporated by reference into this application.

Notice: [Four Digits in a bracket] denote numbers of respective paragraph in the Japanese Specification of the Japanese application JP2003-170228.

### BACKGROUND OF THE INVENTION

The present invention relates to an organic EL light emitting display device of the type which is provided with a region formed of an organic material which emits light due to an electroluminescence phenomenon in each pixel; and, more particularly, the invention relates to an organic EL light emitting display device having a pixel structure that is suitable for an organic EL light emitting display device which displays an image by active matrix driving using a switching element provided to each pixel.

An organic EL light emitting display device (organic electroluminescence display device), which is driven by an active matrix method (also referred to as a TFT type), is expected to be offered as a next-generation flat panel display device, which can replace the current liquid crystal display device.

The pixel constitution and a pixel circuit of the conventional organic EL light emitting display device are disclosed in the following Patent Documents 1 to 5, for example.

[Patent Document 1]

Japanese Unexamined Patent Publication Hei 11-329715.

[Patent Document 2]

National Publication of Translated Version of PCT Application Hei 11-503868.

[Patent Document 3]

National Publication of Translated Version of PCT Application Hei 11-503869.

[Patent Document 4]

U.S. Pat. No. 6,157,356

[Patent Document 5]

U.S. Pat. No. 5,561,440

### SUMMARY OF THE INVENTION

The conventional organic EL light emitting display device has the following structure. On one electrode (for example, an anode electrode, hereinafter the explanation will refer to the anode electrode as the one electrode), using a thick-film bank formed of an organic insulation material (the bank-like structure or the insulation structure between neighboring pixels which forms light emitting portions (also referred to as light emitting regions or light emitting areas) which expose portions of the above-mentioned one electrode), the above-mentioned light emitting areas of the organic EL elements (light emitting layers) which constitute respective pixels are defined. Then, in the inside of the bank, light emitting layers of the organic EL elements are formed, and, at the same time, the light emitting layers are covered with another electrode (for example, a cathode electrode, hereinafter the explanation will refer to the cathode electrode as the other electrode). The anode electrode and the cathode electrode are insulated from each other by an outer periphery of the light emitting area.

It is believe that an unpredicted problem caused by light from the above-mentioned organic EL element is also attributed to the fact that light which is generated in a certain pixel leaks into other neighboring pixels as a stray light through the insulation film (the so-called bank layer) which partitions the light emitting regions (organic material layers) of the organic EL light emitting display device between the pixels. Such leaking of light is recognized by a user of the organic EL light emitting display device as smear or a contrast defect.

Further, from a viewpoint of the contrast of an image displayed by the organic EL light emitting display device, it is extremely important to increase the degree of blackness of the pixel in a non-light-emitting state. In the organic EL light emitting display device, the influence that the leaking of light generated by the reflection of light in the inside of the substrate gives to the black display becomes larger than the corresponding influence in the liquid crystal display device. Accordingly, the high brightness of the pixel in the white display state is also offset by the leaking of light which is generated when the pixel is in the black display state, and, hence, the contrast of the display image is still held at a low level. As a result, it is unavoidable that the displayed image produced by such a device is more deteriorated compared to the display image of a liquid crystal display device.

Further, with respect to an organic EL light emitting display device which uses an organic material as the above-mentioned so-called bank material, in the manufacturing step, when the so-called polymer-based organic EL material is supplied to the respective pixels in a solution state, it is necessary to form openings which have a depth to temporarily store the solution of the organic EL material therein in the bank. Accordingly, in the bottom emission type organic EL light emitting display device which emits light to the TFT substrate side, it is also necessary to take the shrinkage of light emitting regions, which is caused by narrowing of the openings of the bank at the TFT substrate side, into consideration. Accordingly, regions formed on an upper surface of the bank, which are allocated to the formation of the openings, cannot be made significantly small. On the other hand, to each pixel, a pixel circuit which controls an organic EL element formed on the pixel is also provided. Accordingly, in each pixel, it is necessary to ensure that there is a region which can be used for a switching element and a capacitive element included in the pixel circuit. Under such a circumstance, for each pixel, it is required to skillfully arrange the above-mentioned two regions in a plane inside the pixel.

Compared to the above-mentioned organic EL material of high molecular weight, with respect to the so-called organic EL material of low molecular weight which can be supplied to each pixel in a sublimated state, it is possible to make the openings of the bank shallow. However, also in the organic EL light emitting display device provided with the organic EL elements formed of the organic EL material of low molecular weight, in the above-mentioned manner, it is required to arrange the light emitting region and the pixel circuit region in each pixel in a plane.

While such an organic EL light emitting display device has an advantage in that a bright image display of high brightness can be produced, a degradation phenomenon has been observed, which is referred to as an edge growth in which, with respect to a light emitting portion (a light emitting area) of the organic EL element provided to every pixel, a region which becomes non-light-emitting grows from a peripheral portion thereof, and, eventually, the brightness of the whole screen is lowered. As a cause of the generation of edge growth, it has been pointed out that there is a possibility of diffusion of a certain substance, such as moisture, oxygen or the like, which degenerates the organic EL material from the bank, which is formed of the organic thin film for defining the light emitting areas, to the inside of the organic EL elements. When the edge growth is generated, the so-called numerical aperture is decreased, and, hence, the brightness of the above-mentioned screen is lowered as a whole.

It is also observed that the contrast ratio (an ANSI contrast), which is obtained when an ANSI pattern used in the inspection of the display device is displayed on an organic EL light emitting display device that has been manufactured on a trial basis, is held as a low value of approximately 50. It is confirmed that this is attributed to the fact that stray light from the pixel of the white display portion (light emitting portion) reaches the pixel of the black display portion, and this stray light is reflected on the tapered portion of the bank opening of the pixel; and, hence, the brightness of the black display portion cannot be made sufficiently small. Further, when stray light is continuously irradiated onto the screen, this gives rise to smear, thus deteriorating the image quality.

Further, an organic EL element is applied to the thick-film bank which defines the light emitting areas, and the cathode electrode is formed such that the cathode electrode covers the organic EL element and also covers the whole surface of the bank; and, hence, there may be a case in which short-circuiting arises between the cathode electrode and the anode electrode at a stepped portion formed on the opening end portion of the bank.

Accordingly, it is an object of the present invention to provide an organic EL light emitting display device which can overcome the above-mentioned various drawbacks, can enhance the numerical aperture by preventing edge growth, can obviate short-circuiting between an anode and a cathode, and can suppress the generation of smear, thus realizing a high-brightness and high-quality display.

Typical examples of an organic EL light emitting display device to which the present invention is applied will be described hereinafter.

(1) The first example of an organic EL light emitting display device according to the present invention includes a substrate having a main surface, a plurality of pixels arranged two-dimensionally on the main surface of the substrate, a plurality of scanning signal lines arranged in parallel in a first direction on the main surface of the substrate, a plurality of data signal lines arranged in parallel in a second direction which intersects the first direction on the main surface of the substrate, and a plurality of current supply lines arranged on the main surface of the substrate. Each one of the plurality of pixels includes a plurality of active elements, which include a first active element which acquires a data signal transmitted from one of the plurality of data signal lines in response to a voltage signal applied through one of the plurality of scanning signal lines, and a second active element which adjusts a current supplied from one of the plurality of current supply lines in response to the data signal, a data holding element for holding the data signal acquired by the first active element, and an organic electroluminescence element (organic EL element) which emits light in response to the supply of the current which is adjusted by the second active element. Further, light emitting areas of the organic EL elements of neighboring pixels are separated by an inorganic insulation film, which is formed of any one fiber selected from a group consisting of a silicon oxide film, a silicon nitride film, and a silicon oxide nitride film.

(2) The second example of an organic EL light emitting display device according to the present invention includes a substrate having a main surface, a plurality of pixels arranged two-dimensionally on the main surface of the substrate, a plurality of scanning signal lines arranged in parallel in the first direction on the main surface of the substrate, a plurality of data signal lines arranged in parallel in the second direction which intersects the first direction on the main surface of the substrate, and a plurality of current supply lines arranged on the main surface of the substrate. Each one of the plurality of pixels includes a plurality of active elements, which include a first active element which acquires a data signal transmitted from one of the plurality of data signal lines in response to a voltage signal applied through one of the plurality of scanning signal lines, and a second active element which adjusts a current supplied from one of the plurality of current supply lines in response to the data signal, a data holding element for holding the data signal acquired by the first active element, and an organic electroluminescence element (organic EL element) which emits light in response to the supply of the current which is adjusted by the second active element. Further, one electrode of the organic EL light emitting element is formed on the same layer on which a gate electrode of the active element which is connected to the scanning signal line is formed, and light emitting areas of the organic EL elements of neighboring pixels are separated by an interlayer insulation film of the active element.

Further, one electrode of the data holding element is formed of a material equal to a material of one electrode of the organic EL light emitting element and is arranged on the same layer as the gate electrode of the active element, another electrode of the data holding element is formed of the same material as the material of a semiconductor layer of the active element, and the data holding element is constituted of the pair of electrodes and an insulation film which is sandwiched by the pair of electrodes and is formed of the same material as the material of a gate insulation film of the active element.

(3) The third example of the organic EL light emitting display device according to the present invention includes a substrate having a main surface, a plurality of pixels arranged two-dimensionally on the main surface of the substrate, a plurality of scanning signal lines arranged in parallel in the first direction on the main surface of the substrate, a plurality of data signal lines arranged in parallel in the second direction which intersects the first direction on the main surface of the substrate, and a plurality of current supply lines arranged on the main surface of the substrate. Each one of the plurality of pixels includes a plurality of active elements, which include a first active element which acquires a data signal transmitted from one of the plurality of data signal lines in response to a voltage signal applied through one of the plurality of scanning signal lines, and a second active element which adjusts a current supplied from one of the plurality of current supply lines in response to the data signal, a data holding element for holding the data signal acquired by the first active element, and an organic electroluminescence element (organic EL element) which emits light in response to the supply of the current which is adjusted by the second active element. Further, one electrode of the organic EL element is embedded in the inside of an insulation film which surrounds the electrode, and the height of a surface of one electrode is substantially equal to the height of a surface of the insulation film which surrounds the electrode, and a side surface of a pattern end portion of one electrode is insulated from a material which forms the organic EL element.

Further, other specific constitutional examples of the above-mentioned organic EL light emitting display device according to the present invention will be described as follows.

(4) The organic EL light emitting display device is further provided with a first light shielding member which is arranged at a position at which light which is irradiated from the organic EL element arranged at one of the plurality of pixels to the plurality of active elements arranged in one of the plurality of pixels or another one of the plurality of neighboring pixels, and a second light shielding member which is arranged at a boundary between a pair of pixels arranged adjacent to each other among the plurality of pixels and blocks leaking of light occurring between the pair of pixels arranged adjacent to each other among the plurality of pixels at a boundary.

(5) In the organic EL light emitting display device, the plurality of active elements are provided as switching elements such as thin film transistors having channel layers made of polycrystals or pseudo-single crystals of semiconductor, for example. One example of the above-mentioned organic EL element provided to the organic EL light emitting display device includes a transparent electrode which receives a current supplied from the above-mentioned second active element, an insulation film (the above-mentioned bank) which is formed on the transparent electrode and has an opening which exposes a portion of an upper surface of the transparent electrode, and an organic material layer which is formed on a portion of the upper surface of the transparent electrode. The insulation film is formed of a dark (black) material or an inorganic material. The insulation film may be formed of a polyimide-based material. Further, a cross section of the opening of the insulation film may be tapered toward the upper surface of the transparent electrode.

(6) When the above-mentioned organic EL element includes the transparent electrode which receives the current supplied from the above-mentioned second active element, the insulation film (the above-mentioned bank) which is formed on the transparent electrode and has the opening which exposes the portion of the upper surface of the transparent electrode, and the organic material layer which covers the opening of the insulation film and a portion which is formed along the opening of the insulation film and to which the current is supplied through the portion of the upper surface of the transparent electrode, a boundary which is defined between the portion of the insulation film and the organic material layer is covered with the light shielding member as viewed from a main surface of the substrate.

(7) As the light shielding member, at least one of a portion of the scanning signal line and a conductive layer which is formed as one of electrodes of the data holding element is provided.

(8) As the light shielding member, a conductive layer which is formed on the same layer on which the scanning signal line is formed and which is formed on a light emitting region of a periphery of the organic electroluminescence element in a ring shape, an L shape or a U shape as viewed from the main surface of the substrate.

(9) the light shielding member constitutes a portion of a line which is formed on the same layer on which at least one of the data signal line and the current supply line is formed and supplies a current to the organic EL element. For example, the light shielding member is electrically connected with the transparent electrode of the organic EL element which receives the supply of the current from the second active element.

(10) The light shielding member includes an aluminum layer.

(11) The light shielding member is arranged on the plurality of respective pixels and, in each one of the plurality of pixels, the plurality of active elements and the organic EL element are separated along the main surface of the substrate by the light shielding member.

(12) When the above-mentioned organic EL element includes the transparent electrode which receives the current supplied from the above-mentioned second active element, the insulation film which is formed on the transparent electrode and has the opening which exposes the portion of the upper surface of the transparent electrode, and the organic material layer which covers the opening of the insulation film and a portion which is formed along the opening of the insulation film and to which the current is supplied through the portion of the upper surface of the transparent electrode, the first light shielding member and the second light shielding member are formed between the main surface of the substrate and the transparent electrode, and at least one of the first light shielding member and the second shielding member extends toward a lower side of the opening of the insulation film from the lower side of the insulation film.

(13) The first light shielding member is formed of at least one of a portion of the scanning signal line and a conductive layer which is formed as one of electrodes of the data holding element, and the second light shielding member is formed of at least one of a conductive layer which is formed as one electrode of the data holding element and a conductive layer which is connected to the current supply line.

(14) One of the first light shielding member and the second light shielding member is formed of a portion of the scanning signal line and another of the first light shielding member and the second light shielding member is formed of a conductive layer which is formed on the same layer on which the scanning signal line is formed and is formed in a ring shape, an L shape or a U shape on a periphery of a light emitting region of the organic EL element as viewed form the main surface of the substrate.

(15) At least one of the first light shielding member and the second light shielding member is formed of a portion of at least one of the data signal line or the current supply line, or a portion of a line which is formed on the same layer on which at least one of the data signal line and the current supply line is formed and which supplies a current to the organic EL element (for example, being electrically connected to the transparent electrode of the organic EL element which receives the current supplied from the second active element).

(16) The first light shielding member and the second light shielding member include an aluminum layer.

(17) Each one of the plurality of respective pixels is divided along the main surface of the substrate into a region where the plurality of active elements are formed and another region where the organic EL element is formed.

Here, the present invention is not limited to the above-mentioned constitution and various modifications can be made without departing from the technical concept of the present invention.

### BRIEF DESCRIPTION OF THE DRAWINGS

FIG. 1 is a cross-sectional view showing the constitution in the vicinity of one pixel in one embodiment of an organic EL light emitting display device to which the present invention is applied;

FIG. 2 is a plan view of the pixel shown in FIG. 1;

FIG. 3A is a plan view of one pixel and FIG. 3B is an equivalent circuit diagram showing one pixel (pixel element) in one embodiment of the organic EL light emitting display device to which the present invention is applied; is FIG. 4 is a plan view showing a state in which a plurality of the pixels shown in FIG. 3A are arranged in a matrix array;

FIG. 5 is a plan view of a mask having a first photo pattern which is used for forming a pixel array provided to the organic EL light emitting display device by photolithography;

FIG. 6 is a plan view of a mask having a second photo pattern which is used for forming a pixel array provided to the organic EL light emitting display device by photolithography;

FIG. 7 is a plan view of a mask having a third photo pattern which is used for forming a pixel array provided to the organic EL light emitting display device by photolithography;

FIG. 8 is a plan view of a mask having a fourth photo pattern which is used for forming a pixel array provided to the organic EL light emitting display device by photolithography;

FIG. 9 is a plan view of a mask having fifth and sixth photo patterns which is used for forming a pixel array provided to the organic EL light emitting display device by photolithography;

FIGS. 10A-10I are cross-sectional diagrams showing an example of steps in a manufacturing process for fabrication of the organic EL light emitting display device of the present invention;

FIG. 11 is a cross-sectional view showing the constitution in the vicinity of one pixel in another embodiment of an organic EL light emitting display device to which the present invention is applied;

FIG. 12 is a plan view in which a plurality of the pixels shown in FIG. 11 are arranged in a matrix array;

FIG. 13 is a plan view, similar to FIG. 12, in which a step of the manufacturing process of another embodiment of an organic EL light emitting display device, to which the present invention is applied, is shown;

FIG. 14 is a plan view showing a step succeeding the step of FIG. 13 in the manufacture of an organic EL light emitting display device to which the present invention is applied;

FIG. 15 is a plan view showing a step succeeding the step of FIG. 14 in the manufacture of an organic EL light emitting display device to which the present invention is applied;

FIG. 16 is a plan view showing a step succeeding the step of FIG. 15 in the manufacture of an organic EL light emitting display device to which the present invention is applied;

FIG. 17 is a plan view showing a step succeeding the step of FIG. 16 in the manufacture of an organic EL light emitting display device to which the present invention is applied;

FIG. 18 is a plan view showing a step succeeding the step of FIG. 17 in the manufacture of an organic EL light emitting display device to which the present invention is applied;

FIGS. 19A-19H are cross-sectional views showing steps in another manufacturing process for use in the fabrication of an organic EL light emitting display device to which the present invention is applied;

FIG. 20 is a cross-sectional view showing the constitution in the vicinity of one pixel representing still another embodiment of an organic EL light emitting display device to which the present invention is applied;

FIGS. 21A-21I are cross-sectional views showing steps in the manufacturing process for use in the fabrication of still another embodiment of the organic EL light emitting display device shown in FIG. 20;

FIG. 22 is a schematic diagram showing the circuit constitution of the organic EL light emitting display device to which the present invention is applied;

FIG. 23 is a plan view showing the arrangement on a substrate of an example of a product of the organic EL light emitting display device according to the present invention;

FIG. 24 is a developed perspective view showing the overall constitution of an example of a product of the organic EL light emitting display device according to the present invention; and

FIG. 25 is a cross-sectional view taken along a line A-A′ in FIG. 24.

### DETAILED DESCRIPTION

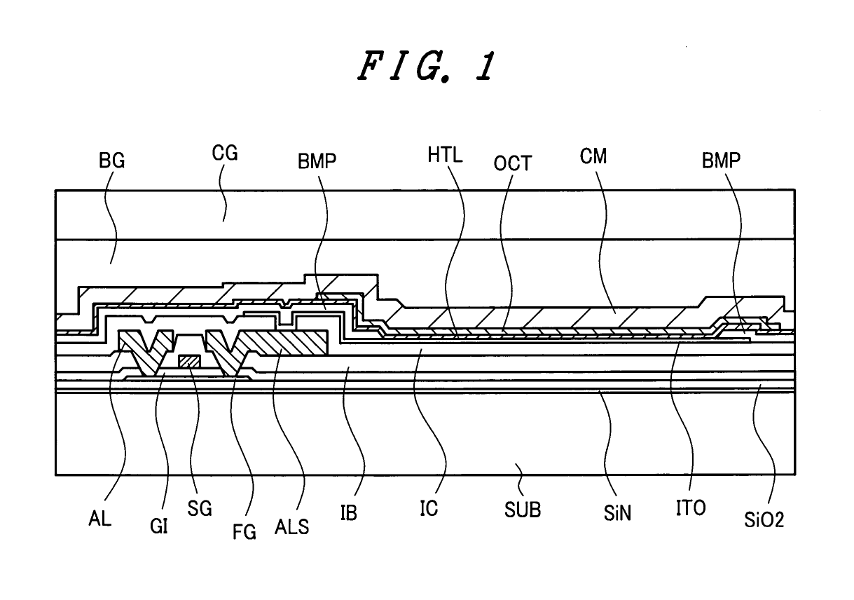

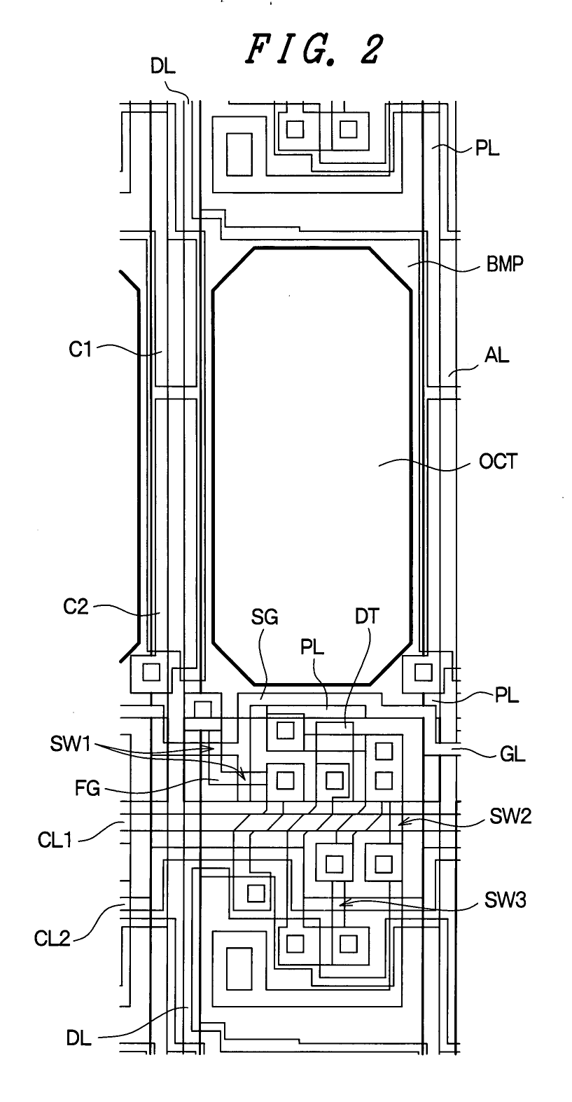

Hereinafter, a mode for carrying out the present invention will be explained in detail in conjunction with the drawings. FIG. 1 is a cross-sectional view of one pixel according to one embodiment of an organic EL light emitting display device to which the present invention is applied. Further, FIG. 2 is a plan view of the vicinity of the one pixel shown in FIG. 1. Here, a case will be considered in which active elements, which constitute switching elements SW1, SW2, SW3, are formed of a thin film transistor. In FIG. 1 and FIG. 2, the reference symbol SUB indicates a substrate, which is preferably made of a transparent glass and has films made of silicon nitride SiN, silicon oxide SiO₂ formed on a main surface thereof and constitutes the above-mentioned TFT substrate. On a switching element region above the silicon oxide SiO₂ film, a first gate FG is formed by patterning of a semiconductor film. A gate insulation film GI is formed to cover the first gate FG, a second gate SG is patterned onto the gate insulation film GI, and, further, an insulation film IB is formed over the second gate SG.

Reference symbol AL indicates a line between the switching elements, which constitutes a drain electrode of the switching element (a line between switches, a signal line, a drain line), and reference symbol ALS indicates a source electrode which also functions as a line between switching elements and as a shielding member (a line between switches and a shielding member) and is connected to a first gate FG through a contact hole which penetrates the insulation film IB and the gate insulation film GI. An insulation film IC is formed to cover the line AL between switches and the shielding member ALS. One electrode ITO, which is connected to the shielding member ALS through a contact hole formed in the insulation film IC, extends to a light emitting area. Here, the one electrode ITO is an anode electrode.

On the one electrode ITO, a bank BMP is formed of an inorganic insulation material and has an opening portion (a bank opening, indicated by reference symbol OPEN in FIG. 4) in a light emitting area thereof. Accordingly, the bank BMP has a shape having a recessed portion in the opening portion. A hole transporting layer HTL and an organic material layer OCT, which constitutes a light emitting layer, are formed to cover the bank BMP and the one electrode (a transparent electrode) ITO exposed to the bank opening. The organic material layer OCT is formed to cover an inner periphery of the bank opening. Then, over a whole surface of the uppermost layer, another electrode (a cathode layer in this embodiment) CM is formed.

In the organic EL light emitting display device according to this embodiment, the light emitting areas of the organic EL elements of the above-mentioned pixels which are arranged adjacent to each other are formed of any one of a silicon oxide film, a silicon nitride film or a silicon oxide nitride film, and they are separated from each other by a bank made of an inorganic insulation film. Accordingly, there is no possibility that water moisture or oxygen will be diffused into the organic EL layer from the bank material, and, hence, the generation of the above-mentioned edge growth is suppressed and an image display having high brightness can be obtained without lowering the numerical aperture.

Further, the bank BMP is formed to have a thickness that is smaller than the thickness of the electrode CM, and the depth of the recess of the electrode CM formed in the bank opening is set to be smaller than the thickness of the electrode CM. Accordingly, the stepped portion of the inner periphery of the bank BMP becomes small, and the reflection of a stray light from a tapered portion of the bank opening is suppressed, and, hence, the lowering of brightness is prevented. As a result, the generation of smear is suppressed. Further, since the stepped portion at the opening end portion of the bank is small, pinholes or cracks are hardly generated in the bank, and short-circuiting between the cathode electrode and the anode electrode, which have occurred conventionally, can be prevented.

Further, one electrode of the organic EL light emitting element is formed on the same level as the gate electrode of the active element, which is connected to the above-mentioned scanning signal line, while the light emitting areas of the organic EL element of adjacent pixels are separated by the interlayer insulation film of the above-mentioned active element. One of the electrodes of the data holding element is formed of the same material as one of the electrodes of the organic EL light emitting element and is arranged on the same layer as the gate electrode of the active element. Another of the electrodes of the data holding element is formed of the same material as the semiconductor layer of the active element. The above-mentioned data holding element is constituted of a pair of electrodes and an insulation film, which is sandwiched between the pair of electrodes, and it is made of the same material as the gate insulation film of the above-mentioned active element.

Further, one electrode of the organic EL element is embedded in the insulation film which surrounds the electrode, the height of the front surface of the above-mentioned one electrode is substantially equal to the height of the front surface of the insulation film which surrounds the electrode, while the side surface of a pattern end portion of the above-mentioned one electrode is isolated from the material forming the organic EL element.

In this manner, it is possible to provide an organic EL light emitting display device which can enhance the numerical aperture by preventing edge growth, which can obviate the short-circuiting between the anode/cathode, and which can suppress the generation of smears, thus realizing a display having high brightness and high quality.

Here, the substrate SUB which forms the stacked film structure on the main surface thereof has a main surface side thereof sealed with a cover glass CG, and a desiccant (not shown in the drawing) is filled into or an inert gas is charged into a gap BG defined by the sealed structure, and, thus, the organic EL light emitting display device is completed.

Further, in the plan view shown in FIG. 2, reference symbol indicates a data signal line, reference symbol GL indicates a scanning signal line, reference symbol PL indicates a current supplying line, reference symbols CL1, CL2 indicate control signal lines, reference symbols C1, C2 indicate conductive layers constituting capacitive elements (capacitors), and reference symbol DT indicates a switching element constituting a drive transistor.

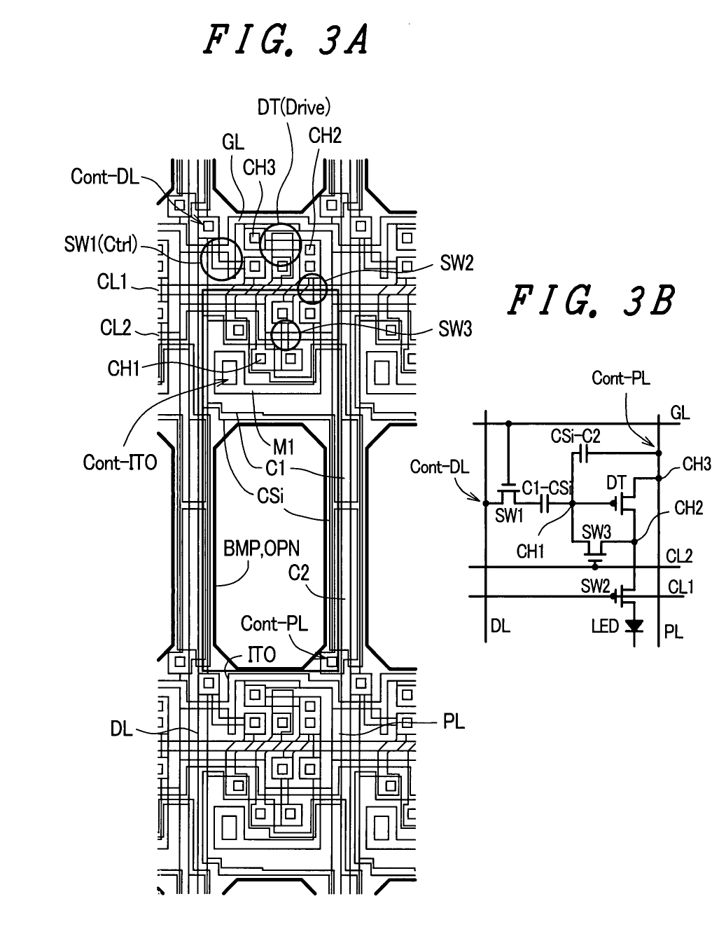

FIG. 3A is a plan view showing one pixel in one embodiment of the organic EL light emitting display device to which the present invention is applied. FIG. 3B shows an equivalent circuit of this one pixel (the pixel element) in conformity with the switching elements SW1, SW2, SW3, DT, the capacitive elements C1-CSi, CSi-C2 and the contact holes to be described later (shown in double-lined rectangular shape in FIG. 3(A)) Cont-DL, Cont-PL and nodes (node) formed as CH1, CH2, CH3.

Respective conductive layers C1, C2 which constitute capacitive elements are specified by reference symbols which are shown as pairs between the semiconductor layers CSi, which are provided as the pair of electrodes which sandwich an insulation material layer (a dielectric layer) and the conductive layer C1 or C2 which is laid above the semiconductor layers CSi. Although an organic EL element (a light emitting element) LED which is provided for every pixel is included in the equivalent circuit, the organic EL element LED is not completely shown in FIG. 3A. In FIGS. 3A and 3B, the organic EL element LED is constituted of a transparent electrode ITO (a profile thereof being indicated by a chained line in FIG. 3A) and an organic material layer and an electrode layer (neither of them being shown in FIG. 3A) which are sequentially stacked on the transparent electrode ITO.

FIG. 4 is a plan view showing a portion of an image display region of the organic EL light emitting display device of the present invention. In the image display region of the organic EL light emitting display device of the present invention, there is provided a so-called active matrix pixel array in which a plurality of the pixels shown in FIG. 3A are two-dimensionally arranged, as shown in FIG. 4. Respective members (semiconductor layer CSi or the electrode layers C1, C2) which are included in the equivalent circuit for one pixel shown in FIG. 3B are substantially surrounded by a frame indicated by a broken line, which corresponds to the pixel region PIX shown in FIG. 4.

In FIG. 3A, an octagonal profile indicated by reference symbol OPN indicates an opening portion of the bank BMP. The bank BMP is an insulation layer formed on the periphery of an upper surface of the transparent electrode ITO, and the above-mentioned organic material layer (indicated by reference symbol OCT in FIG. 2) is brought into contact with an upper surface of the transparent electrode ITO that is exposed from the opening. The bank BMP electrically separates the organic material layer formed on the transparent electrode ITO, which constitutes one electrode for every pixel, and the opening portion OPN of the bank BMP substantially agrees with the light emitting region of the organic EL element LED formed for every pixel (see FIG. 3B).

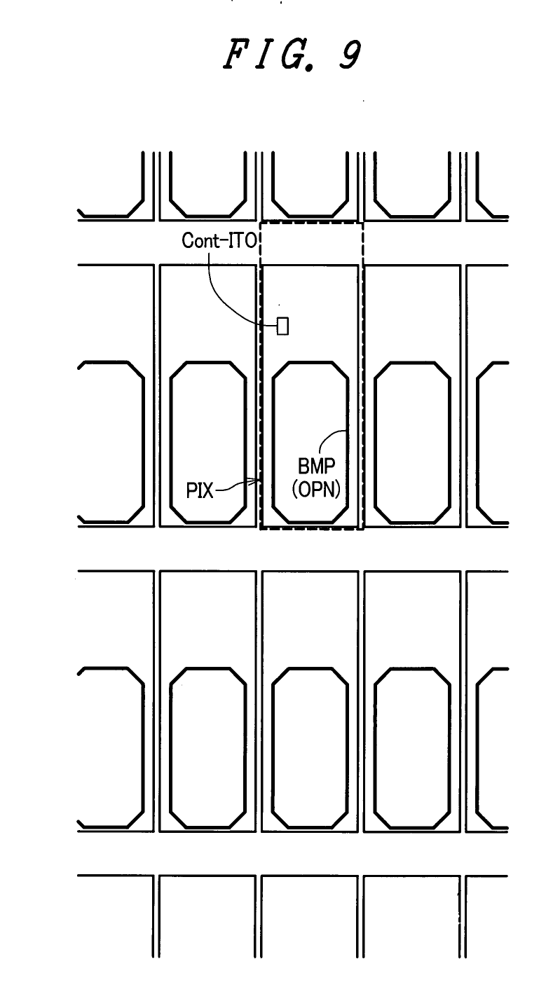

On the other hand, in this embodiment, the above-mentioned electrode layer (described later as the member CM in conjunction with FIGS. 10A-10I and ensuing drawings), which constitutes the organic EL element LED by sandwiching the organic material layer together with the transparent electrode ITO, bridges over the plurality of pixels and is formed like a counter electrode (a common electrode) in a twisted nematic (a so-called TN type) liquid crystal display device. In FIG. 3A, to the organic EL element LED, which is shown as the opening OPN of the bank BMP, a current (a charge), which sequentially passes a current path constituted of a node CH3, a switching element DT, a node CH2, a switching element SW2 from a branched line of a current supply line PL, is supplied through the transparent electrode ITO, which is electrically connected to the current path through a contact hole Cont-ITO. In the drive transistor DT and the switching element SW2 respectively (surrounded by circles in FIG. 3A), the current path is formed as a semiconductor layer (indicated with thick gray in the drawing) and an electrode layer (indicated with thin gray in the drawing) which is made of metal or alloy is formed on the semiconductor layer by way of an insulation layer. In other words, the flow of charge in the above-mentioned current path is controlled by the drive transistor DT and the switching element SW2 (an electric field applied to the corresponding semiconductor layer) which are provided to the current path. For example, the charge of the current path which passes the switching element SW2 is controlled in response to an electric field applied to a control signal line CL1.

The injection of the current to the organic EL element LED in each pixel of this embodiment shown in FIGS. 3A and 3B is controlled in response to a video signal (voltage signal) supplied from the drain line (video signal line) DL for every pixel. In other words, the current which corresponds to the video signal transmitted through the drain line DL is applied to the organic EL element LED. The switching element SW1 is also referred to as a control transistor and the scanning signal line GL is formed to bridge over the semiconductor layer which is electrically connected with the drain line DL twice at the node Cont-DL within a circle which shows the region. As in the case of the switching element SW1 shown in FIG. 3A, the gate electrode (the scanning signal line GL in this embodiment) which intersects the channel layer (the semiconductor layer) twice is also referred to as a dual gate. The video signal which is outputted from the switching element SW1 reaches the conductive layer C1, which constitutes one of a pair of electrodes which constitute the capacitive element C1-CSi, through the conductive layer which bridges over two control signal lines CL1, CL2. Accordingly, to the respective pixels which belong to each one of a pixel row arranged in parallel along the drain line (a group of pixels which are arranged in the direction which intersects the extension direction of the drain line), in response to the scanning signal transmitted through the scanning signal line GL corresponding to the pixel row, the video signal is input from the drain line DL, and the voltage is held in the capacitive element C1-CSi until the next video signal is inputted to each pixel. The capacitive element C1-CSi functions like the capacity which is constituted of a pair of electrodes which sandwich the liquid crystal layer in the TN type liquid crystal display device.

On the other hand, the brightness of the organic EL element LED is controlled by the drive transistor DT, which is provided to the current path which supplies the current to the organic EL element LED. Accordingly, this switching element is referred to as the drive transistor. As shown in FIG. 3A and FIG. 3B, in this embodiment, in the circle which outlines the drive transistor DT, a conductive layer which is electrically connected with the semiconductor layer CSi, which constitutes another of the pair of electrodes which form the capacitive element C1-CSi at the node CH1, is formed above the semiconductor layer of the above-mentioned current path. Accordingly, the current which corresponds to the voltage held by the capacitive element C1-CSi in response to the video signal inputted from the drain line DL is written in the light emitting region of the organic EL element (corresponding to the above-mentioned opening OPN of the bank) from the current supply line PL through the drive transistor DT.

Here, although the scanning signal lines GL are formed in a zigzag shape to avoid the contact holes (indicated by a duplicate quadrangular shape in FIG. 3A) which constitute the above-mentioned nodes Cont-DL or the like, in the image display region as a whole, as illustrated in FIG. 4, the scanning signal lines GL extend in a direction which intersects the extending direction of the drain lines DL and the current supply lines PL. The scanning signal line GL extends in the inside of the pixel along the light emitting region (the opening OPN) of the neighboring pixel (the upper side in FIG. 3A) and is overlapped to the branch line of the above-mentioned current supply line PL. The scanning signal lines GL, which are formed in this manner, are laid at the upper side (the neighboring pixel side) compared to the respective channel layers (the semiconductor layers indicated with thick gray in the drawing) of the above-mentioned switching elements SW1, SW2, SW3, DT provided to the pixel. Accordingly, by forming the scanning signal lines GL using a material such as a metal, alloy or the like which easily absorbs light and easily reflects light, it is possible to shield these channel layers from light which is generated in another pixel (the upper neighboring pixel in FIG. 3A) which is arranged close to and along the drain line DL or the current supply line PL. Particularly, by forming the branch line of the current supply line PL using a material which easily absorbs or easily reflects light, a portion of the scanning signal line GL, which is overlapped to the branch line, can efficiently shield the respective channel layers from light (one portion of the scanning signal line GL being surrounded is by a circle which outlines the light shielding layer GLS in FIG. 4). Such a scanning signal line GL constitutes one of the features of the light shielding structure of the present invention. Here, in place of the scanning signal line GL, the above-mentioned light shielding structure may be formed using the control signal lines CL1, CL2 which extend in a direction which intersects the extending direction of the drain signal line DL and the current supply line PL.

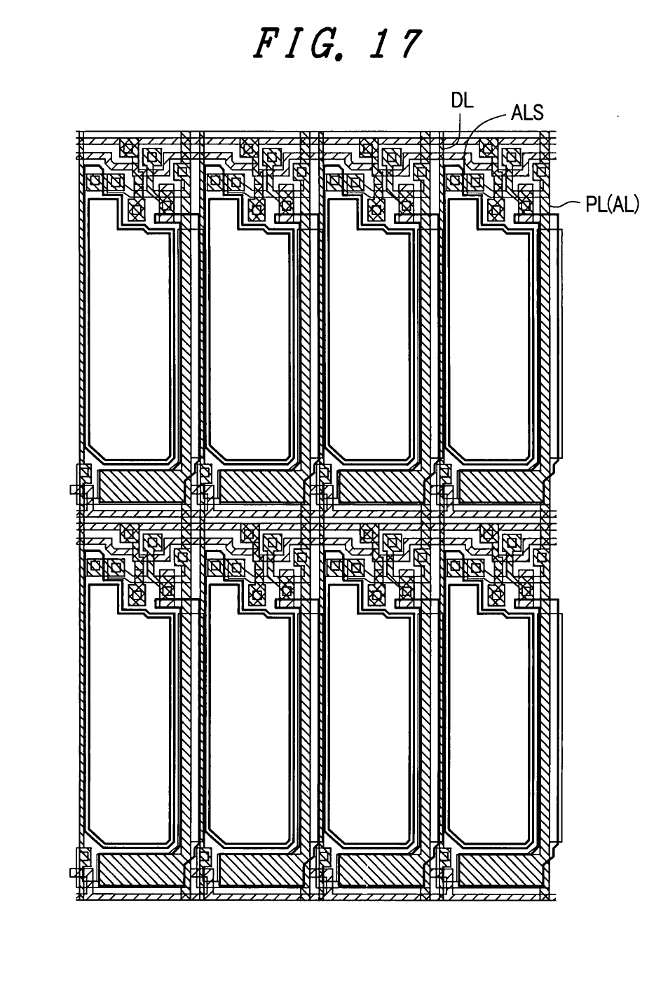

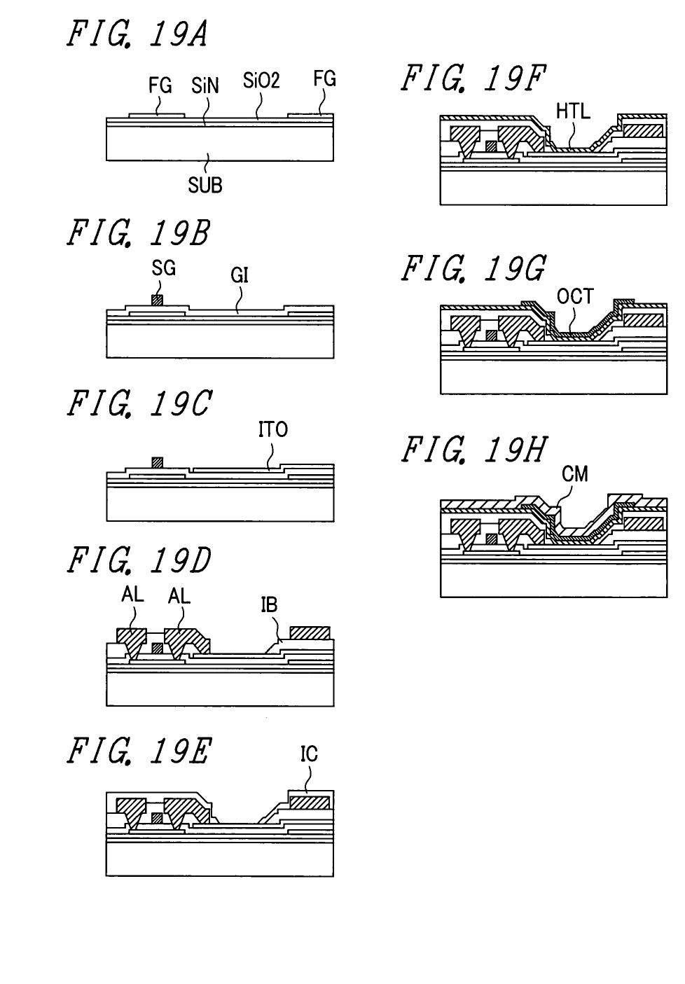

As shown in FIGS. 3A and 3B, each pixel described in connection with this embodiment is provided with two control signal lines CL1, CL2 and the switching elements SW2, SW3 which are controlled by either one of the control signal lines CL1, CL2. In the so-called current-driven type organic EL light emitting display device which controls the brightness of the organic EL element LED based on a current supply quantity to the organic EL element LED, in view of the operation principle thereof, the arrangement of the control signal lines CL1, CL2 and the switching elements SW2, SW3 is not always necessary. For example, in the organic EL light emitting display device shown in FIG. 18 or in the pixel structure shown in FIG. 20, these control signal lines and switching elements are not provided. Provided that there are no irregularities with respect to the characteristics (particularly “threshold voltage value”) of the drive transistors DT which are arranged in the respective pixels, or in the case where the irregularities can be ignored, it is possible to put the organic EL light emitting display device having the pixel structure shown in FIG. 20 into a practical use.

Further, by a method which performs modulation of the brightness in response to control of a time-sequential axis using a linear region of the characteristics of the drive transistor DT, it is possible to put the organic EL light emitting display device into practical use. However, when the channel layer of the drive transistor DT is formed of polycrystal or pseudo-single crystal of a semiconductor material such as silicon or the like, it is not deniable that the condition for crystallization (for example, annealing by laser irradiation) differs between the pixels. The difference in the condition for crystallization allows the coexistence of pixels which differ in the characteristics of the drive transistor DT in the inside of the image display region of one organic EL light emitting display device. As a result, for example, in the inside of the image display region of the organic EL light emitting display device to which the image data, which produces a display using the same gray scale over the whole screen, is inputted, a difference in brightness (brightness irregularities) arises.

In this embodiment, one of the motivations to provide two control signal lines CL1, CL2 and the switching elements SW2, SW3 which are respectively controlled by the control signal lines CL1, CL2 shown in FIG. 3A and FIG. 3B, lies in making the characteristics of the drive transistors DT, which become non-uniform in the inside of the image display region in the above-mentioned manner, substantially uniform. This function can be explained as follows. Control signals which differ in timing from each other are supplied to the control signal lines CL1 and CL2 from a control signal supply circuit not shown in FIG. 3A and FIG. 3B.

To be more specific, first of all, in response to the control signal transmitted through the control signal line CL1, the switching element (first input switch) SW2 is turned on. Here, although the drive transistor DT is not turned on, a node CH2 side of the drive transistor DT is connected to the reference potential through the organic EL element LED from a floating state and the potential is elevated to a given value or more. Next, a control signal which is transmitted through the control signal line CL2 turns on the switching element (the second input switch) SW3 corresponding to the control signal. Accordingly, one electrode CSi of the capacitive element CSi-C2, which is in a floating state, is connected to the node CH2 side of the drive transistor DT through the switching element SW3, and the potential thereof is elevated to a is given value. Here, since the gate potential (the potential of the node CH1) of the drive transistor DT is equal to the potential of the output side (node CH2 side) of the drive transistor DT, the channel layer of the drive transistor DT interrupts the flow of charge.

Since a given current flows into the current supply line PL irrespective of the video signal transmitted through the drain line DL, the potential of the current supply line PL is substantially fixed. Accordingly, by sequentially turning on and off two switching elements SW2, SW3 (by sequentially placing the channel layers of respective switching elements in a conductive state), a substantially equal quantity of charge is stored in the capacitive elements CSi-C2 of any pixels. In such a state, when the channel layer of the switching element SW3 is closed and, subsequently, the switching element (control transistor) SW1 is turned on, in response to a voltage (a video signal) applied to one electrode C1 of the capacitive element C1-CSi, the capacitance of the capacitive element C1-CSi is also changed; and, in response to the change of the capacitance of the capacitive element C1-CSi, a difference arises between the potential of the node CH1 (the gate potential of the drive transistor DT) and the potential of the output side (node CH2 side). Due to this potential difference, with respect to the pixel of this embodiment, the drive transistor DT is turned on or a charge quantity which flows into the turned-on channel is controlled so as to allow the organic EL element LED to emit light at the desired brightness.

Although the channel layer of the drive transistor DT is turned on with respect to a given usual gate potential (a threshold voltage Vth), when the channel layer is, for example, formed as a polycrystalline layer or a pseudo-single crystal layer of a semiconductor material, as described previously, the threshold voltage Vth differs in response to the pixel. In this embodiment, an operational point of the drive transistor DT which is dependent on such a threshold voltage Vth is set using the potential of the node CH1 given by the capacitive element CS1-C2 as a reference, and the ON/OFF operation of the drive transistor DT is controlled based on the capacitive balance between the capacitive element CS1-C2 and the capacitive element C1-CSi, whereby the operation of the drive transistor DT is stabilized and the correction of irregularities of the threshold voltage Vth which is generated between the pixels can be performed. The details of the respective manners of operation of the switching elements SW1, SW2, SW3, DT are as follows.

The switching element SW1, which is also referred to as the control transistor, is a switch which inputs a video signal voltage for every pixel and is provided not only to the pixel of this embodiment, but also to a pixel of an organic EL light emitting display device which controls a conductive state of a channel layer of the drive transistor DT based on a threshold voltage Vth. The switching element SW1 is turned on/off in response to the scanning signal transmitted to the scanning signal line GL, which intersects the channel layer (the semiconductor layer) and writes the video signal voltage inputted from the drain line DL into the capacitive element (the capacitor) of the so-called pixel circuit provided for every pixel.

When the image data is written, for example, one time for every frame period (vertical scanning period), into the image display region of the organic EL light emitting display device which drives the organic EL element provided to each pixel by current injection, the period in which the switching element SW1 provided to each pixel is turned on is limited to the horizontal scanning period which is allocated for the scanning signal line GL. Accordingly, the current injection quantity (a charge injection quantity) to the organic EL elements which are included in the pixel row corresponding to each scanning signal line GL is also limited. In such a current-driven type organic EL display device, in contrast to a voltage-driven type display device, such as a TN type liquid crystal display device, it is difficult to hold the brightness of the pixel for a given period using the switching element SW1 which is used for acquiring the image data (the video signal). Accordingly, as described previously, another switching element, which is also referred to as the drive transistor DT, and the current supply line PL are provided for every pixel, and the conductive state of the channel layer of the drive transistor DT is held for a given period, whereby the brightness of each pixel is ensured. The capacitive element which is connected to the output side of the switching element (the control transistor) SW1 holds the gate potential of the above-mentioned drive transistor DT at a desired value for a predetermined period, so as to maintain the current injection to the organic EL element LED. Accordingly, even when the conductive state of the drive transistor DT is controlled using the threshold voltage Vth as a reference, as well as, when the conductive state of the drive transistor DT is controlled substantially in accordance with this embodiment, it is recommended to provide the capacitive element at the output side of the switching element SW1.

In the switching element SW1 of this embodiment, as shown in FIG. 3A, the channel layer has a dual gate structure in which the channel layer intersects the scanning signal line GL at two portions thereof. With the control of these two portions, an operation to write the signal voltage supplied from the drain signal line DL into one electrode C1 of the capacitive element C1-CSi can be performed in a stable manner. Further, due to this dual gate structure, leaking of the charge stored in the electrode of the switching element SW1 side (drain line DL side) of the capacitive element (the conductive layer C1 in this embodiment) can be suppressed, whereby the gate potential of the drive transistor DT can be stabilized for a given period.

The switching element SW2 performs not only the above-mentioned function of controlling the storing of a charge to one electrode (semiconductor layer) CSi of the capacitive element CS1-C2, but also has the function of a current supply switch from the drive transistor DT to the organic EL element LED. The latter function is used for writing the current which is supplied from the current supply line PL and is adjusted in response to the video signal inputted from the drain line at the drive transistor DT into the organic EL element LED when the switching element SW2 is turned on. The latter function is used not only in this embodiment, but also in a case in which a conductive state of the drive transistor DT is controlled using the threshold voltage Vth as a reference. Such a switching element (the current supply switch SW2) is subjected to ON/OFF control at the timing of the control signal line CL1.

The switching element SW3 is a switch for storing the threshold voltage Vth of the drive transistor DT in the capacitor CS1-C2 and is a switching element peculiar to the pixel circuit of the embodiment shown in FIG. 3B.

The drive transistor DT has, as shown in FIG. 3A, a relatively long gate length in which, compared to other switching elements SW1, SW2, SW3, the conductive layer which covers the channel layer (the semiconductor layer) of the drive transistor DT is elongated along the extension direction of the channel layer. The drive transistor DT of this embodiment is turned on corresponding to the balance between the charge stored in the capacitive element CSi-CS through the switching element (timing switch) SW3 and the charge stored in the capacitive element C1-CSi through the switching element (the control transistor) SW1. Due to such a constitution, the current which corresponds to the video signal supplied from the drain line DL is made to flow to a position immediately ahead of the switching element (current supply switch) SW2 through the contact hole CH3 formed in the branch line of the current supply line PL. Further, in response to the turning on of the current supply switch SW2, the current of the current supply line PL is written in the organic EL element LED.

FIG. 4 is a plan view in which the pixels shown in FIG. 3A are arranged in a matrix array. One pixel shown in FIG. 3A corresponds to a pixel region PIX which is surrounded by a bold broken line in FIG. 4. The organic EL light emitting display device according to the present invention includes an image display region having the active matrix structure in which the pixels shown in FIG. 3A are arranged two-dimensionally, as shown in FIG. 4.

One electrode (semiconductor layer) CSi which is provided to the respective capacitive elements (capacitors) C1-CS1, CS1-C2 included in the equivalent circuit of one pixel shown in FIG. 3B is shown as a region defined by a thick line, which extends from the upper side to the right side of the bank opening OPN (the light emitting region having the organic material layer OCT) of the pixel region PIX shown in FIG. 4. Another electrode C1 of the capacitive element C1-CSi also extends from the upper side to the right side of the bank opening OPN and is formed above the semiconductor layer CSi by way of an insulation material layer (a dielectric layer). Another electrode C2 of the capacitive element CS1-C2 is formed above the semiconductor layer CSi which extends to right lower side of the bank opening OPN by way of the insulation material layer (the dielectric layer) and is electrically connected with the current supply line PL formed above another electrode through a contact hole Cont-PL formed in a right lower corner of the pixel region.

At the respective capacitive elements C1-CS1, CS1-C2, the charge is supplied to the semiconductor layer CSi which constitutes one electrode through the switching elements SW2, SW3. The charge is supplied to another electrode C1 (indicated by a thinner line than that indicating the semiconductor layer CSi) of the capacitive element C1-CSi from the drain line DL provided at the left end of the pixel region PIX through the contact hole Cont-DL and the switching element SW1. The charge is supplied to another electrode C2 (indicated by thinner line than that indicating the semiconductor layer CSi) of the capacitive element CS1-C2 from the current supply line PL formed at the right end of the pixel region PIX through the contact hole Cont-PL.

More specifically, portions of the respective semiconductor layer CSi and the conductive layers C1, C2 corresponding to the pixel region PIX shown in FIG. 4 project outwardly from the right end of the bold broken-line frame which indicates the pixel region PIX and portions of the respective semiconductor layer CSi and the conductive layers C1, C2 corresponding to the pixel region arranged close to the left side of the pixel region PIX enter the inside of the bold broken-line frame which indicates the pixel region PIX.

As described above, in the organic EL light emitting display device of this embodiment, the charges which are stored in the respective semiconductor layer CSi and conductive layers C1, C2 which constitute two capacitive elements (capacitors) provided corresponding to the pixel region PIX determine a current quantity which is written in the light emitting region of the organic EL element (the organic material layer OCT formed on the bank opening OPN) from the branch line of the current supply line PL, which extends toward the upper end of the pixel region PIX through the contact hole CH3, the switching element DT, which is referred to as the drive transistor, and the contact hole Cont-ITO. Here, in the pixel region PIX shown in FIG. 4, the transparent electrode layer ITO shown in FIG. 3A is omitted.

In the organic EL light emitting display device of this embodiment, as the switching elements SW1, SW2, SW3 and the drive transistor DT, which are provided for every pixel, a field effect type transistor (also described as a thin film transistor or a poly-Si TFT) made of polycrystalline silicon (also referred to as poly-Si) and having a channel layer is used. In the display device which drives a plurality of respective pixels which are arranged on the image display region using switching elements (poly-Si TFTs) of this type, due to a photovoltaic effect which is generated when light is irradiated to the channel layers (polycrystalline layers) of the switching elements provided for every pixel, the conductive states of the channel layers are liable to be easily changed, and, hence, there exists a possibility that the brightness of the pixel which is driven by the switching element (TFT) goes beyond a desired value, thus giving rise to degradation of the image quality of the image display region.

Particularly, with respect to the pixel of the active matrix type organic EL light emitting display device, since the organic EL element (the light emitting portion) and the active element (the switching element) which controls the organic EL element are arranged close to each other, light having an intensity reaching several hundred thousand luxes is irradiated to the channel layer of the switching element from the oblique direction. For example, even when a light shielding structure similar to the light shielding structure of the conventional TFT type liquid crystal display device described in U.S. Pat. No. 5,561,440 is applied to the pixel of the organic EL light emitting display device, it is impossible to shield the channel layer of the switching element from this strong light. Accordingly, in the present invention, as illustrated in this embodiment, the electrode layer of the capacitive element (the capacitor) of the circuit (pixel circuit) which is formed for every pixel is, as the light shielding material, arranged between the channel layer of the switching element made of polycrystalline silicon (poly-Si) and the light emitting portion of the organic EL element LED, thus preventing degradation of the image displayed on the organic EL light emitting display device.

In one pixel region PIX, indicated by being surrounded by a bold broken line in FIG. 4, the conductive layer C1 which constitutes one electrode of the capacitive element C1-CSi provided for every pixel of the organic EL light emitting display device is made of a material having low optical transmissivity (for example, high-melting-point metal such as molybdenum-tungsten (MoW), titanium-tungsten (TiW) or an alloy thereof, a silicide thereof) and is formed between the bank opening portion OPN, in which the light emitting portion (the organic material layer OCT) is formed, and the group of switching elements (SW1, SW2, SW3, DT). On the other hand, in this embodiment, another electrode of the above-mentioned capacitive element C1-CSi is formed of a polycrystalline silicon layer CSi together with the channel layers of the above-mentioned switching elements SW1, SW2, SW3, DT. Since the polycrystalline silicon layer CSi absorbs light incident thereon by 90% at maximum, together with the above-mentioned one electrode (the conductive layer C1) of the capacitive element formed above the polycrystalline silicon layer CSi, the light from the above-mentioned light emitting portion (organic material layer OCT) is prevented from being irradiated to the respective channel layers of the above-mentioned group of switching elements in the inside of the pixel region PIX.

As shown in FIGS. 3A and 4, in each pixel of the organic EL light emitting display device of this embodiment, the conductive layers CS1, C1, C2 which constitute the electrodes of two capacitive elements (capacitors) C1-CSi, CSi-C2, which are provided to each pixel, are also formed below the current supply line PL and the drain line DL. In this manner, by extending the conductive layers CS1, C1, C2 along the current supply line PL, which is arranged between the pixel regions, and the drain line DL, which is arranged close and parallel to the current supply line PL, the capacitor regions (areas in which the pair of electrodes face each other) of the capacitive elements C1-CS1, CS1-C2 are enlarged to a maximum, and the light emitting region in the pixel region PIX is also enlarged to a maximum. As described above, the organic EL light emitting display device drives the light emitting portions of respective pixels by current driving, and, hence, even when the electrodes C1, C2 of the above-mentioned capacitive elements C1-CS1, CS1-C2 are arranged to face the current supply line PL and the drain line DL in an opposed manner, crosstalk is hardly generated.

Here, the capacitive elements C1-CS1, CS1-C2 in this embodiment are not limited to the structure in which the capacitive elements C1-CS1, CS1-C2 are overlapped to both the current supply line PL and the drain line DL which are arranged in parallel between the neighboring pixels. That is, the capacitive elements C1-CS1, CS1-C2 may be overlapped to either one of the current supply line PL and the drain line DL in accordance with areas of the capacitor regions corresponding to the respective required capacitances. In both cases, the capacitive element C1-CSi (a portion) and the capacitive element CS1-C2, which extend along the current supply line PL and the drain line DL, interrupt any leaking of light which is generated between the neighboring pixels along the extending direction of the scanning signal line GL. In the organic EL light emitting display device, the capacitive element C1-CSi which is provided for every pixel is necessary to hold the signal voltage (the video signal) from the drain line DL. However, it is not necessary to make the capacitive element C1-CSi extend below at least one of the current supply line PL and the drain line DL to also work as a shielding member for blocking light between the above-mentioned pixels. In other words, the leaking of light between the neighboring pixels along the scanning signal line GL can be suppressed by at least one of the capacitive element C1-CSi and the capacitive element CS1-C2. Here, it is not always necessary that one electrode C2 of the capacitive element CS1-C2 is connected to the current supply line PL at the contact hole Cont-PL, as shown in FIGS. 3A and 2. That is, the potential of the electrode C2 of the capacitive element CS1-C2 may be set in a floating state, for example.

In the embodiment shown in FIG. 4, a boundary between the above-mentioned two conductive layers C1, C2 appears in the vicinity of the center of the pixel region PIX in the longitudinal direction. From a viewpoint of enhancing the above-mentioned shielding function against leaking of light between the pixels, it is desirable not to form a discontinuous portion of the shielding member (the light shielding member) in the vicinity of the center of the light emitting portion (the organic material layer OCT). For example, it is preferable to form the whole shielding member between the pixels using the capacitive element C1-CSi. Further, in place of the above-mentioned capacitive element C1-CSi and capacitive element CS1-C2, a shielding member having a ring shape, an L shape or a C shape which is electrically independent from the pixel circuit may be additionally provided. Further, the ring-shaped shielding member which surrounds the pixel region PIX may be formed discontinuously at a position that is sufficiently spaced apart from the center of the light emitting portion (the organic material layer OCT) (for example, a corner portion of the pixel region PIX), and, hence, a portion of the shielding member may be replaced with a portion GLS of the scanning signal line GL shown in FIG. 2. Further, on the same layer as the scanning signal line GL, a ring-shaped conductive layer which is electrically separated from the scanning signal line may be newly provided as a shielding member.

As shown in FIG. 4, in the pixel region PIX, by forming the capacitive element C1-CSi between the scanning signal line GL and the control signal lines CL1, CL2 and the opening portion OPN (the light emitting portion formed of the organic material layer OCT) of the bank and by arranging the portion GLS of the scanning signal line GL at an end portion of the pixel region PIX, light from the opening portion OCT of the bank is hardly irradiated to the respective channel layers of the group of switching elements (SW1, SW2, SW3, DT) formed in the inside of the pixel region PIX. Further, by arranging the capacitive element C1-CSi and the capacitive element CS1-C2 on the current supply line PL and the drain line DL, which are arranged along the end portion of the pixel region PIX in an overlapped manner, mixing of light from two neighboring pixels is hardly generated. Accordingly, in the organic EL light emitting display device of this embodiment, a desired light emitting quantity (brightness) can be obtained from respective organic EL elements which are arranged in the image display region, whereby a beautiful and vivid image can be displayed.

As described above, in the organic EL light emitting display device, the organic EL element which is arranged for every pixel region PIX has the possibility of generating strong light. When such strong light is irradiated to the switching elements (SW1, SW2, SW3, DT in this embodiment) provided with the channels made of polycrystalline silicon (poly-Si), the silicon layers (the Si layers) which constitute the channels generate a photovoltaic effect corresponding to the intensities of the electric fields. Accordingly, an electric field generated in the channel (Si layer), in spite of the fact that the switching element applies an electric field in a turn-off state to the channel, for example, generates a positive hole electron pair in the inside thereof, and, hence, the charge holding characteristics of the switching element are deteriorated. For example, the charge (determining a control voltage of the drive transistor DT) stored in the capacitive element C1-CSi leaks to the drain line DL through the channel of the switching element (the control transistor) SW1 in a turn-off state. As a result, the current which is supplied to the organic EL element through the drive transistor DT is reduced.

Such a drawback does not appear in an outstanding manner in the conventional TFT type liquid crystal display device, and, hence, it is impossible for the light shielding structure adopted by the liquid crystal display device to shield the switching element from the strong light received from the organic EL element. Particularly, in the bottom emission type organic EL light emitting display device of this embodiment, in which the organic EL element LED is formed by sequentially stacking the transparent electrode ITO, the organic material layer OCT and the electrode layer from the substrate main surface side, (TFT substrate side) and in which light generated by the organic material layer OCT is emitted to the TFT substrate side, light emitted from the pixel region PIX is liable to easily irradiate the channel of the switching element formed on the pixel region PIX, and, hence, the image quality of a display image obtained by the control of the switching element (so-called TFT driving) is liable to be easily degraded.

Accordingly, in the organic EL light emitting display device according to this embodiment, the electrodes (conductive layers) C1, C2 of the above-mentioned respective capacitive elements C1-CS1, CS1-C2 are designed to function also as light shielding layers. To be more specific, as illustrated in FIG. 4, the capacitive elements C1-CS1, CS1-C2 are arranged at both ends of the opening portion OPN of the bank along the current supply line PL or the drain line DL so as to increase the widths of respective electrodes C1, C2 along the extending direction of the scanning signal line GL (the direction which intersects the extending direction of the current supply line PL or the drain line DL). Accordingly, light which leaks in the extending direction of the scanning signal line GL in FIG. 4 is blocked by the electrodes C1, C2. When the areas of the electrodes C1, C2 are limited due to the capacitances required to the capacitive elements C1-CS1, CS1-C2, a line M1 which eventually supplies the current from the current supply line PL to the transparent electrode (see FIG. 3A, the detail of the line M1 being explained later and also being referred to as reference symbol ALS) is extended, or the width of at least one of the current supply line PL and the drain line DL is increased, to form light shielding layers which replace the electrodes C1, C2.

Further, as shown in FIG. 4, a portion of the electrode (conductive layer) C1 of the capacitive element C1-CSi is formed between the light emitting region (bank opening OPN) and the switching elements SW1, SW2, SW3, thus also performing light shielding of the inside of the pixel region PIX (the upper side of the light emitting region). A portion of the electrode C1 which is arranged close to the upper end of the opening OPN of the bank has, to enhance a light shielding effect thereof, the width thereof increased along the current supply line PL or the drain line DL, and, at the same time, a contact hole Cont-ITO which electrically connects the line M1 and the above-mentioned transparent electrode ITO is formed above the electrode C1, as shown in FIG. 3A.

Further, in this embodiment, for performing the light shielding of the lower side of the pixel region PIX (the end portion of the pixel region PIX arranged adjacent to another pixel region along the current supply line PL or the drain line DL), a portion GLS of the scanning signal line which contributes to the driving of another pixel region is arranged at an upper end of another pixel region as a light shielding layer. To observe the inside of the pixel region PIX, the above-mentioned portion GLS of the scanning signal line shields the switching element SW1 arranged below the portion GLS from the light emitting region of another pixel region arranged above and adjacent to the pixel region PIX.

As described above, in the organic EL light emitting display device according to the present invention, as described in connection with this embodiment, the bank arranged between neighboring pixels is formed of the inorganic material, and the thickness of the bank is made smaller than the thickness of the electrode above the bank, and, hence, the generation of edge growth is prevented whereby lowering of the numerical aperture can be prevented and lowering of the brightness is obviated. Further, with use of a thin bank made of an inorganic material, the slope which is formed on an inner periphery of the bank can be set to a value which can be almost ignored; and, hence, lowering of the brightness attributed to the reflection of a stray light from the neighboring pixel on the slope of the bank can be suppressed, and, at the same time, since there is substantially no stepped portion, the generation of short circuiting between the electrodes which sandwich the organic EL layer can be prevented.

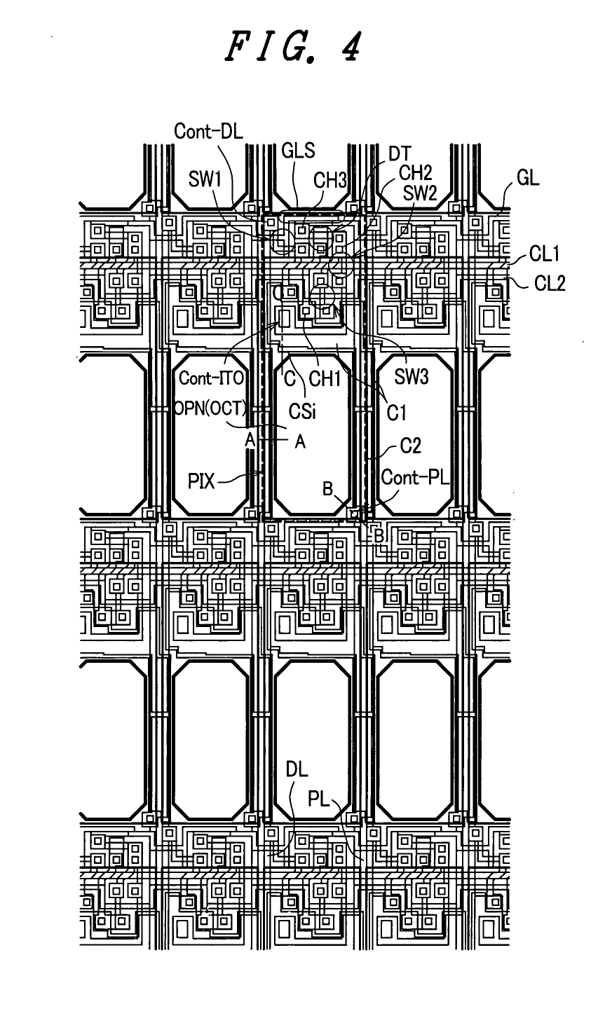

Further, this embodiment adopts a structure in which the capacitive elements (capacitors) and the scanning signal line which are provided for every pixel region are respectively arranged at the upper side, the lower side, the left side and the right side of the light emitting region (the organic material layer OCT) so as to prevent light from the organic material layer OCT from being irradiated to the switching elements SW1, SW2, SW3. The above-mentioned photovoltaic effect, which appears in the channel layers of the switching elements, is not so large as to influence the respective functions of the switching elements SW1, SW2, SW3 with respect to the function of the drive transistor DT (the drive transistor DT being turned on during the light emitting period of the light emitting region). Accordingly, with respect to four switching elements which are arranged in the pixel region PIX, although the drive transistor DT can be arranged closer to the light emitting region compared to three other switching elements, as shown in FIG. 5, it is desirable to arrange the light emitting region (the light emitting region OPN′ at the upper side of the pixel region) and the light shielding member (the portion GLS of the scanning signal line) in a spaced apart manner from each other. Further, the current supply line PL, which is formed above the electrodes (conductive layers) C1, C2 of the capacitive elements C1-CS1, CS1-C2 in an overlapped manner, can also block the leaking of light in the same manner as these electrodes C1, C2.

The pixel array (the portion of the image display region) which is provided to the organic EL light emitting display device of this embodiment shown in FIG. 1 to FIG. 4 is formed by photolithography using a mask having six kinds of photo patterns, as shown in FIG. 5 to FIG. 9. In the photo patterns which are shown in FIG. 5 to FIG. 9, respectively, to facilitate correspondence with the pixel array structure shown in FIG. 4, the region which corresponds to the pixel region PIX illustrated in FIG. 4 is surrounded by a bold broken frame PIX.

Further, FIGS. 10A-10I are diagrams showing steps of a manufacturing process in the fabrication of the organic EL light emitting display device of this embodiment, as shown in FIG. 1 to FIG. 4. Insulation layers SiN, SiO₂ are formed on the substrate SUB, and a first gate FG is patterned on the insulation layers SiN, SiO₂ (FIG. 10A). Next, a gate insulation film GI is formed, and a second gate SG is patterned on the first gate FG (FIG. 10B). After forming the insulation film IB, an inter-switch line AL, which also forms a drain electrode, and an inter-switch line/shielding member ALS, which also forms a source electrode, are formed (FIG. 10C). An insulation film IC is formed on the inter-switch line AL and the inter-switch line/shielding member ALS (FIG. 10D), a transparent conductive film ITO which is connected with the inter-switch line/shielding member ALS is formed (FIG. 10E), and a bank BMP is formed using an inorganic insulation material (FIG. 10F). The transparent conductive film ITO which constitutes one electrode is exposed through an opening portion of the bank BMP, and a hole transport layer HTL is formed as a film on the whole surface of an upper portion of the bank BMP including the opening portion (FIG. 10G). Next, an organic EL light emitting layer is formed on the above-mentioned opening (FIG. 10H), and, finally, another electrode (a cathode electrode) CM is formed on the opening portion (FIG. 10I).

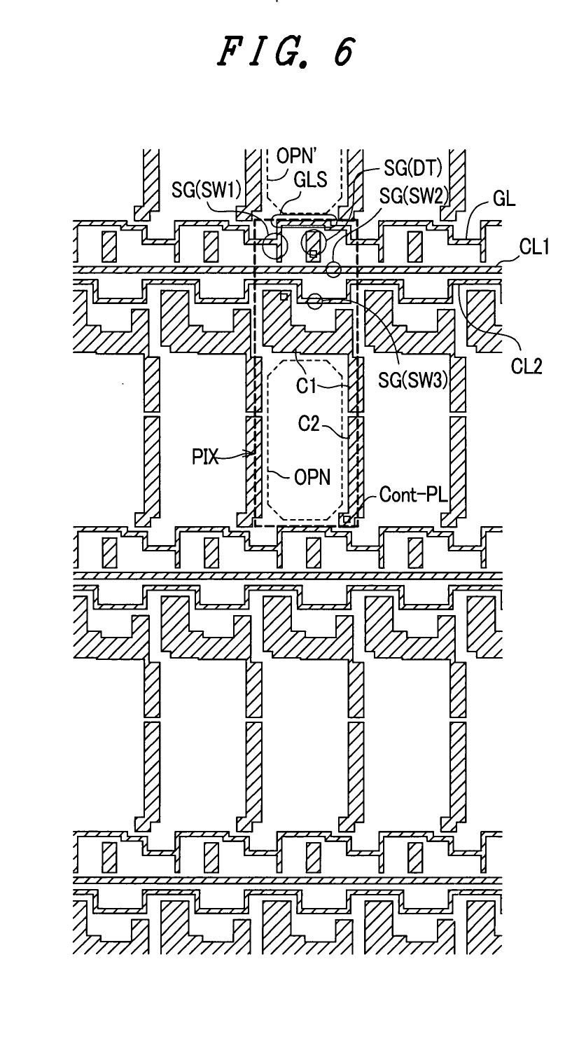

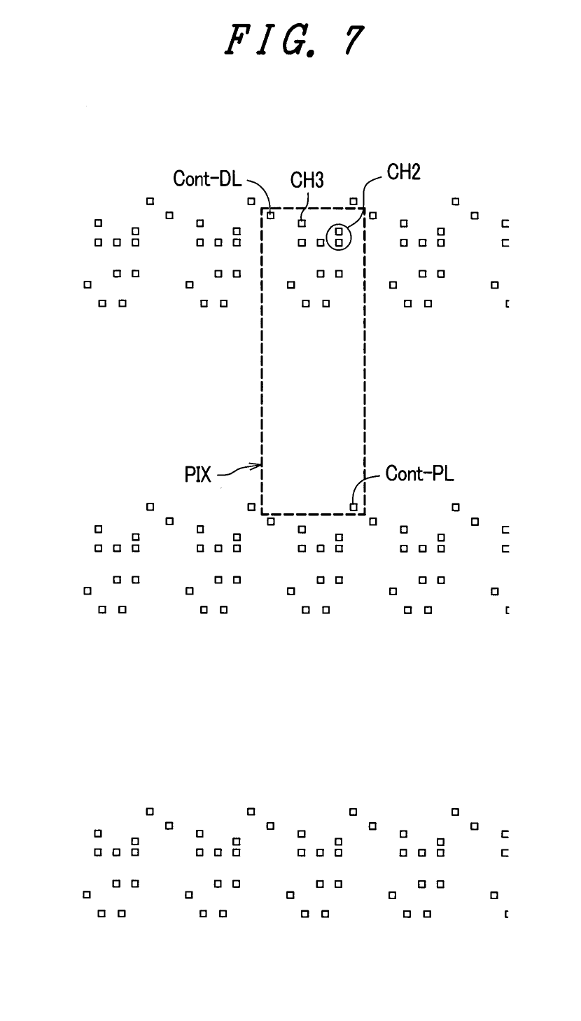

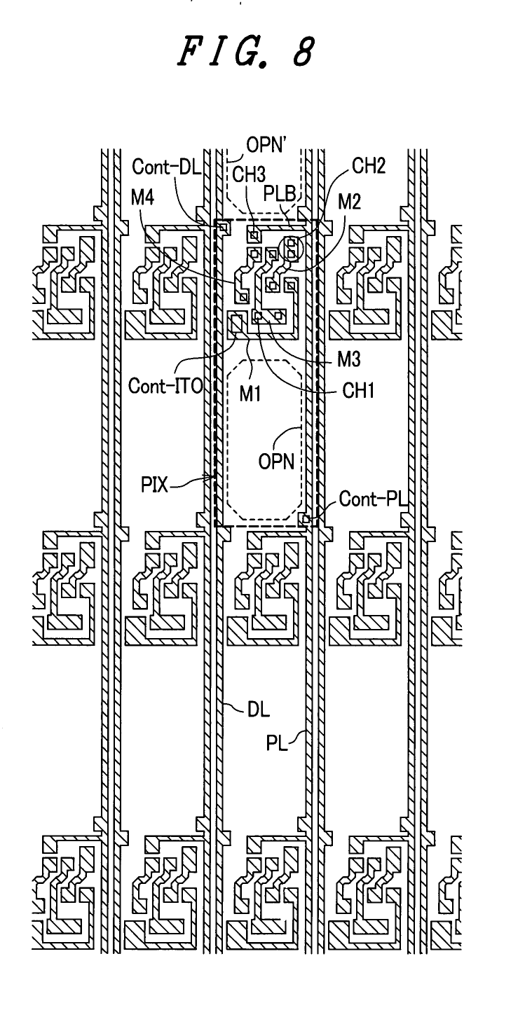

In FIGS. 5, 6 and 7, only with respect to the pixel region PIX, among rectangular patterns of the contact holes (for example, Cont-DL, CH3) shown in FIG. 7, only a group of contact holes relevant to the electric connection to the semiconductor layer and the conductive layers which are formed by respective photo patterns is illustrated. Further, in FIGS. 5, 6 and 8, the pixel region PIX and bank openings OPN, OPN′ of another pixel region, which is arranged adjacent to the upper side of the pixel region PIX, are indicated by fine broken frames. Further, in FIGS. 8 and 9, only with respect to the pixel region PIX, the rectangular contact hole Cont-ITO which electrically connects the line M1 shown in FIG. 3A and the transparent electrode ITO which constitutes a portion of the organic EL element is shown. These constitutional features are, as can be clearly understood from the photo pattern of other pixel regions other than the pixel region PIX, not included in the photo patterns corresponding to respective drawings, and, in FIGS. 5, 6, 7 and 8, reference symbols which distinguish these parts are described in italic.

FIG. 5 shows the first photo pattern used for forming the pixel array shown in FIG. 4 in which the plurality of pixels are arranged in a matrix array. On an insulation film 1A formed on a main surface of a quartz substrate when a quartz substrate is used as the above-mentioned TFT substrate, and on an insulation film 1A formed on a main surface of a soda-lime glass when the soda-lime glass is used as the above-mentioned TFT substrate, thin films and openings which constitute the pixel array are sequentially formed by photolithography as will be explained hereinafter, which uses seven masks on which the first photo pattern to the seventh photo pattern are respectively depicted. Here, in photolithography ranging from the first photo pattern to the sixth photo pattern, the pixel circuit which drives the organic EL element is completed in each pixel region. In this embodiment, the channel of the switching element included in the pixel circuit is formed of an amorphous silicon layer, wherein the mobility of electrons in the channel is enhanced by transforming the amorphous silicon layer into a polycrystalline silicon layer by a process performed at a relatively low temperature using laser irradiation or the like. Accordingly, a series of steps ranging from the first photo pattern to the sixth photo pattern is also referred to as a low-temperature polysilicon step or a LTPS step. To the contrary, in photolithography using the seventh photo pattern, the bank opening OPN which constitutes the light emitting portion of the organic EL element is formed. Accordingly, the step which uses the seventh photo pattern is referred to as an organic light emitting diode step or an OLED step. Due to the LTPS step and OLED step, the organic EL light emitting display device provided with the pixel array shown in FIG. 2 is completed.

In the first photo pattern shown in FIG. 5, the channel regions of the switching elements (TFTs in this embodiment) and the silicon layers (Si layers) forming the substrate-side (lower-side) electrodes of the capacitive elements (capacitors) C1-CS1, CS1-C2 which are included in the pixel circuit are formed in a colored pattern. To be more specific, the channel regions FG (SW1), FG (SW2), FG (SW3), FG (DT) of the switching elements SW1, SW2, SW3, DT formed of a polycrystalline silicon layer and the silicon regions CSi which face the lower surfaces of the above-mentioned conductive layers C1, C2 are formed. Here, the silicon region CSi makes the stepped portion of the first insulation film (the gate insulation film GI of the switching element shown in FIG. 10B), which is formed above the silicon region CSi, gentle so as to prevent the breaking of the above-mentioned conductive layer formed on the insulation film. Among the semiconductor layers formed in the photolithography step which uses a mask on which the first photo pattern is formed, there may be a case in which the semiconductor layers used for respective channels of the switching element are indicated collectively by reference symbol FG in the following explanation.

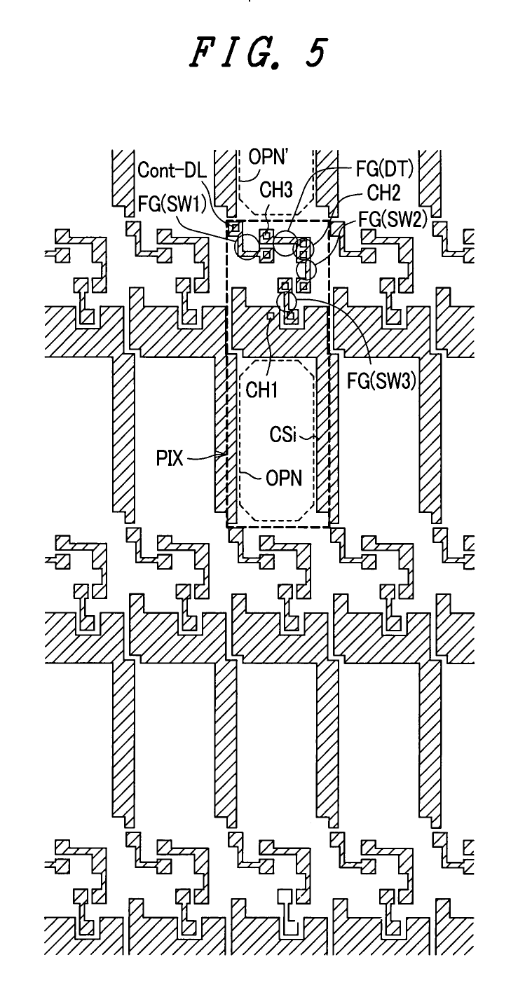

FIG. 6 shows the second photo pattern used for forming the pixel array shown in FIG. 4. Using the second photo pattern, on the above-mentioned first insulation film, the scanning signal lines GL (also functioning as the control electrodes SG(SW1) of the switching elements SW1), the control signal lines CL1, CL2, the conductive layers C1, C2 which constitute the upper electrodes of the capacitive elements C1-CSi, CSi-C2 and the control electrodes SG(DT) of the drive transistor DT are collectively formed as a shaded pattern shown in FIG. 6. The control signal line CL1 controls the current supply to the organic EL element LED shown in FIG. 3B and applies the control signal to the control electrode SG(SW2) of the switching element SW2 which adjusts the drive conditions of the drive transistor DT. Further, in this embodiment which provides the capacitive element CSi-C2 to the pixel circuit for adjusting the drive conditions of the drive transistor DT, the switching element SW3 is further provided for supplying a given charge to the capacitive element CSi-C2 so as to adjust the current supplied to the organic EL element LED in response to the video signal. Accordingly, in this embodiment, there is also provided the control signal line CL2 for applying the control signal to the control electrode SG(SW3) of the switching element SW3. Among the conductive layers which are formed in the photolithography step using the mask on which the second photo pattern is formed, there may be a case in which the conductive layers which are used as the respective control electrodes of the switching elements (including the drive transistor DT) are collectively referred to using reference symbol SG in the following explanation.

As described above, the scanning signal line GL has both the function of controlling the acquiring of the video signal in the channel region of the of switching element SW1 into the pixel region and the function of blocking light which leaks from the separate pixel region arranged close to the pixel region toward the group of switching elements of the pixel region. Accordingly, as shown in FIG. 6, the scanning signal line GL is formed in a step-like manner which repeats bending with respect to the extending direction (the lateral direction in FIG. 6) of the scanning signal line GL. From a viewpoint of the light shielding characteristics of the scanning signal line GL, it is preferable to arrange the portion GLS which also performs the light shielding function as close as possible to an end of the pixel region (in other words, the light emitting portion OCT of the separate pixel region arranged close to the pixel region).

Further, the upper electrodes (the conductive layers) C1, C2 of the capacitive elements C1-CSi, CSi-C2 are also requested to have a light shielding function together with the scanning signal line GL, as previously explained. Accordingly, the conductive layers which are formed using the second photo pattern are formed using a material and thickness suitable for suppressing the optical transmissivity. The material of the conductive layer is selected by focusing on the absorbance and the reflectance. For example, by focusing on the former viewpoint, a refractory material which is exemplified by molybdenum (Mo), tungsten (W), titanium (Ti), chromium (Cr), an alloy thereof or a silicide thereof are recommended. Further, by focusing on the latter viewpoint, aluminum (Al) and an alloy thereof are recommended. These materials may be stacked in plural layers.

Here, in FIG. 6, the portion GLS of the scanning signal line which also functions as the light shielding member is formed to have a width equal to the width of a portion of the control electrode SG(SW1) of the switching element SW1. However, it is possible to set the width of the portion GLS of the scanning signal line to be larger than the width of other portions of the scanning signal line GL so as to increase the light shielding performance. Due to such a constitution, the light shielding characteristics with respect to the pixel region connected to the scanning signal line of a next stage (indicated above the pixel region PIX, for example, in FIG. 6) is enhanced. Further, in this embodiment, although the scanning signal line GL is formed in a step-like manner, as in the case of a conventional TFT type liquid crystal display element driven by an active matrix method, the scanning signal line GL may be formed linearly. The shape of the scanning signal line GL is suitably changed in response to the number and the layout of the switching elements formed for every pixel region.

FIG. 7 shows the third photo pattern used for forming the pixel array shown in FIG. 4. The third photo pattern is a pattern of contact holes which are bored from an upper surface of the second insulation film (for example, the insulation film IB shown in FIG. 10) which covers the conductive layers such as the scanning signal lines GL formed by the second photo pattern toward a main surface of the substrate (the TFT substrate). The respective contact holes formed by this pattern electrically connect the conductive layers (formed on the above-mentioned second insulation film), which will be explained later in conjunction with the fourth pattern shown in FIG. 8, and either one of the semiconductor layers formed using the first photo pattern and the conductive layers formed using the second photo pattern. Accordingly, nine contact holes (including the contact holes Cont-DL, CH1, CH2, CH3) out of the twelve contact holes shown in the inside of the pixel region PIX in FIG. 5 are also shown on the upper surface of the semiconductor layers (CSi, FG) in the inside of the pixel region PIX shown in FIG. 5. Further, the remaining three contact holes (including the contact hole Cont-PL) out of the twelve contact holes shown in the inside of the pixel region PIX in FIG. 5 are also shown on the upper surface of the conductive layers (C1, C2, SG(DT)) in the inside of the pixel region PIX shown in FIG. 6.

The functions of the contact holes shown in FIG. 7 will be briefly explained by taking the contact holes Cont-PL, Cont-DL as examples in conjunction with FIGS. 3B and 4. The contact holes Cont-PL connect the upper electrode (the conducive layer) C2 of the capacitive element CS1-C2 formed on the above-mentioned first insulation film using the second photo pattern and the current supply line PL formed on the above-mentioned second insulation film using the fourth photo pattern shown in FIG. 8 through the second insulation film. In response to a stored quantity of charge in the lower electrode (the semiconductor layer) CSi of the capacitive element CSi-C2, which is changed at the timing of the applying of the control signal (the scanning signal) from the scanning signal line GL to the switching element SW1, the charge is supplied to the upper electrode (the conductive layer) C2 from the current supply line PL through the contact holes Cont-PL.

On the other hand, the contact holes Cont-DL is formed using the first photo pattern, and it connects one end (also referred to as the drain region) of the channel layer FG(SW1) of the switching element (the control transistor) SW1 which is covered with the above-mentioned first insulation film and the drain line DL which is formed on the second insulation film using the fourth photo pattern through the first and second insulation films. When the channel layer FG(SW1) of the switching element (the control transistor) SW1 is turned on in response to the application of the control signal from the scanning signal line GL, the video signal (the voltage signal) from the drain line DL is applied to the upper electrode C1 of the capacitive element C1-Csi through the contact hole Cont-DL and the channel layer FG(SW1). The charge quantity stored in the capacitive element C1-Csi controls, together with the charge quantity stored in the capacitive element CS1-C2, the voltage applied to the control electrode SG(DT) of the drive transistor DT. Accordingly, at the time the switching element SW1 is turned on, the current corresponding to the video signal flows into the channel FG(DT) of the drive transistor DT. The current corresponding to the video signal is written into the transparent electrode ITO through the switching element SW2, the line M1 and the contact hole Cont-ITO. The current corresponding to the video signal written into the transparent electrode ITO flows through the organic material layer OCT formed on the transparent electrode ITO into another electrode CM (described later in conjunction with FIGS. 8 and 9), which is included in the organic EL element LED together with the organic material layer OCT, and it makes the organic material layer OCT (the electroluminescence material layer included in the organic material layer OCT) emit light.

FIG. 8 shows the fourth photo pattern used for forming the pixel array shown in FIG. 4. With the use of the fourth photo pattern, the respective lines M1, M2, M3, M4 which are connected with the current supply line PL, a branch line PLB thereof, the drain line DL and at least one of a group of switching elements (SW1, SW2, SW3, DT) which include the above-mentioned drive transistor are formed on the above-mentioned second insulation film as a shaded pattern shown in FIG. 8.

The line M1 is formed as a current path provided between the output side of the switching element SW2 and the node (contact hole) Cont-ITO which is connected to the transparent electrode ITO of the organic EL element LED. The line M2 is formed as a charge path provided between one end of the drive transistor DT and one end of the switching element SW3. The line M3 electrically connects another end of the switching element Sw3, the semiconductor layers CSi which constitute the lower electrodes of the capacitive element C1-CSi and the capacitive element CSi-C2 and the control electrode SG(DT) of the drive transistor DT with each other and functions as a charge path which starts from another end of the switching element SW3 and reaches the semiconductor layer CSi and a voltage signal path which starts from the node (the contact hole) CH1 and reaches the control electrode SG(DT) of the drive transistor. The line M4 is formed as a voltage signal path which is provided between the output side (also referred to as a source) of the switching element SW1 and the upper electrode C1 of the capacitive element C1-CSi.

Since the current supply line PL is also included in the conductive layers formed using the fourth photo pattern, it is desirable to set the resistance of the conductive material formed in the photolithography step using this mask to be lower than the resistance of the conductive material in the photolithography step using the mask having the second photo pattern. For example, aluminum or an alloy thereof or silicide is recommended as the conductive material formed using the fourth photo pattern.

In this embodiment, using aluminum as the conductive material, the current supply line PL and the branch line PLB thereof, the drain line DL and the group of lines M1, M2, M3, M4 are formed on the second insulation film. Further, using aluminum, the current path, the charge path and the voltage signal path which reach any one of the semiconductor layers CSi, FG and the conductive layers C1, C2, SG(DT) which are laid below the second insulation film through the contact holes formed using the third photo pattern are respectively formed. Accordingly, in the explanation of the embodiment made hereinafter, there may be a case in which the above-mentioned conductive layers PL, PLB, DL, M1, M2, M3, M4 which are formed in the photolithography step using the mask on which the fourth photo pattern is formed are indicated by reference symbols AL, ALS.

FIG. 9 shows jointly the fifth photo pattern and the sixth photo pattern which are used for forming the pixel array shown in FIG. 4. Here, before the photolithography step which uses the mask having the fifth photo pattern, the third insulation film (the insulation film IC shown in FIG. 10D) is formed on the conductive layers AL such as the current supply line PL, the line M1 and the like which are formed using the fourth photo pattern and the contact hole Cont-ITO is formed in the region positioned above the line M1. The drawings relevant to this step are omitted.

The fifth photo pattern only has a pattern represented by a rectangular frame ITO shown in FIG. 9. Accordingly, the transparent electrodes ITO are formed in a strip shape on the above-mentioned third insulation film and some of the transparent electrodes ITO are electrically connected with the line M1 through the contact holes Cont-ITO. The transparent electrode ITO which is formed in the photolithography step which uses the mask having the fifth photo pattern is formed as an amorphous layer or a polycrystalline layer of a conductive oxide which allows light to pass therethrough and is represented by Indium Tin Oxide (Indium-Tin-Oxide, also abbreviated as ITO) or Indium Zinc Oxide (Indium-Zinc-Oxide, also abbreviated as IZO). In the organic EL light emitting display device, it is required to form an electroluminescence material layer (included in the organic material layer OCT) as a light emitting portion having a uniform thickness and flatness. Further, the high temperature process which decomposes the organic material layer OCT must be excluded in view of the manufacturing step. Under such circumstances, since the conductive oxide such as the above-mentioned Indium-Zinc-Oxide or the like can obtain a film having less roughness of the surface thereof even when the temperature of the heat treatment is suppressed to a low level, a conductive oxide is suitable for the organic EL light emitting display device shown in this embodiment. After forming a transparent electrode ITO for each pixel region in the photolithography step which uses the mask having the fifth photo pattern, on the upper surface of the transparent substrate ITO and the upper surface of the above-mentioned third insulation film on which the transparent electrode ITO is not formed, the fourth insulation film, which is formed on the bank BMP to be described later, is formed.

The sixth photo pattern has only a pattern shown by an octagonal frame BMP in FIG. 9 and, accordingly, an octagonal opening is formed in the fourth insulation film which covers the above-mentioned transparent electrode ITO and the third insulation film, and, hence, the bank BMP is completed. The bank BMP (the fourth insulation film) is formed of an organic film made of polyimide or the like or an inorganic film made of SiO₂ or the like. Since the light emitting region of the organic EL element is formed by supplying an organic material in is a sublimed state or as droplets onto the transparent electrode ITO, it is recommended to form recessed portions which separate the current flowing in the organic material layer OCT (electroluminescence material layer included in this organic material layer OCT) for each pixel. Therefore, on the transparent electrode ITO, the bank BMP formed of the insulation film which separates the light emitting region for each pixel is formed. In the organic EL light emitting display device of this embodiment, the bank BMP having the octagonal opening portion (shown as reference symbol OPN in FIG. 2) is overlapped to the periphery of the transparent electrode ITO and the center portion of the transparent electrode ITO (corresponding to the light emitting region) is exposed through the opening portion of the bank BMP.

In the organic EL light emitting display device according to the present invention, the above-mentioned fourth insulation film which constitutes the bank BMP is formed using any one of inorganic materials such as SiO₂ or SiNₓ or the like and a black material, wherein the thickness of the fourth insulation film is smaller than the thickness of another electrode which is formed above the fourth insulation film. The bank BMP which is formed of the latter material is referred to as the black bank hereinafter. The black bank BMP is, for example, formed of a positive type photosensitive black polyimide. As a material of this type, in this embodiment, JR 3120P, a product of Nitto Denko Ltd. is exemplified. As described above, since the organic material layer OCT is formed in the opening of the bank BMP, the light emitting region which is included in the organic material layer OCT and the bank BMP are optically coupled. Accordingly, when the bank BMP is transparent or semi-transparent with respect to light from the organic material layer OCT, there exists a possibility that the light from the organic EL element LED formed in a pixel propagates to the inside of the bank BMP and is leaked as a stray light to the other pixels arranged close to this pixel. This leaking of the light between the pixels is recognized as smears by an observer. However, as in the case of this embodiment, by forming the fourth insulation film having a thickness smaller than the thickness of the other electrode which is formed above the fourth insulation film, such leaking of the light can be suppressed, and, hence, the current flowing in the light emitting region is assuredly separated for each pixel whereby the definition of the display image of the organic EL light emitting display device is enhanced and the deterioration of the display quality of the display image attributed to the light from the light emitting region which propagates within the display device can be prevented.

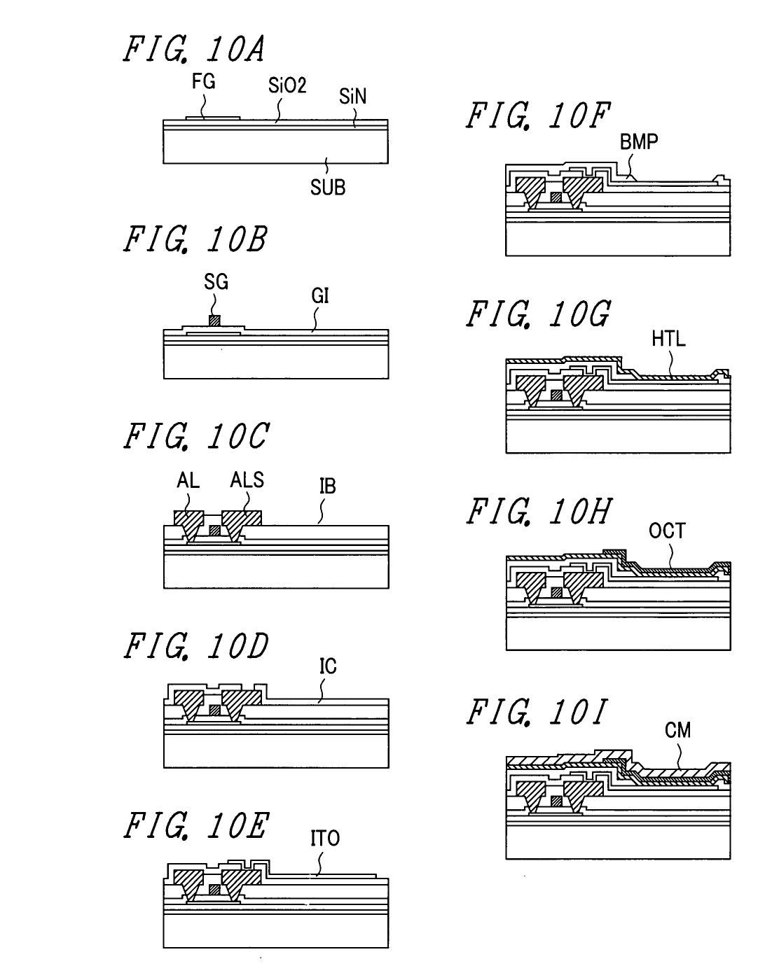

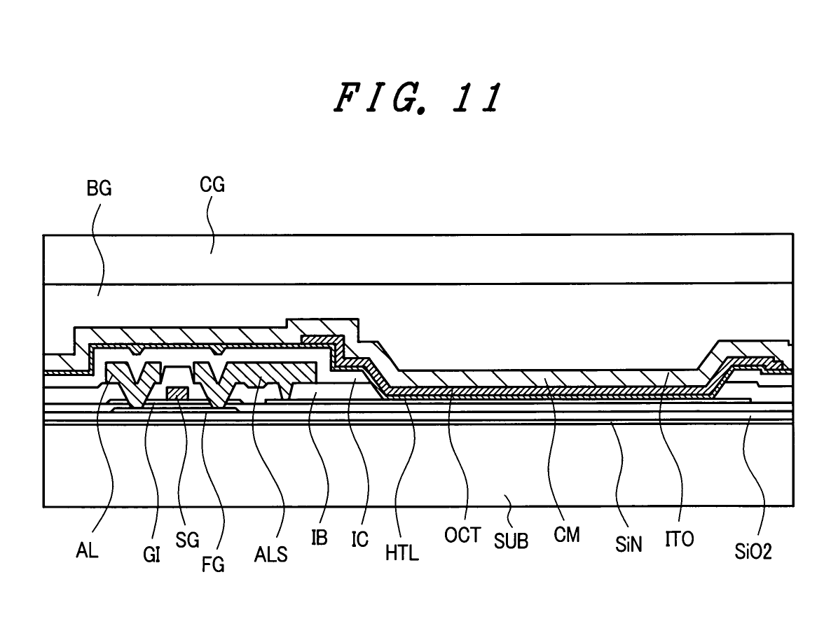

FIG. 11 is a cross-sectional view showing the constitution of the vicinity of one pixel of another embodiment of the organic EL light emitting display device which adopts the present invention. The constitution which makes FIG. 11 different from FIG. 1 lies in the fact that a bank BMP is formed of insulation films IB and IC and a transparent conductive film ITO which forms another electrode (anode electrode) is connected with a line which connects between switches and a shield electrode ALS below the bank BMP via a contact hole which penetrates the bank BMP. The parts identified by the same reference symbols used in FIG. 1 correspond to parts having identical functions. Further, FIG. 12 is a plan view in which the pixels shown in FIG. 11 are arranged in a matrix array.

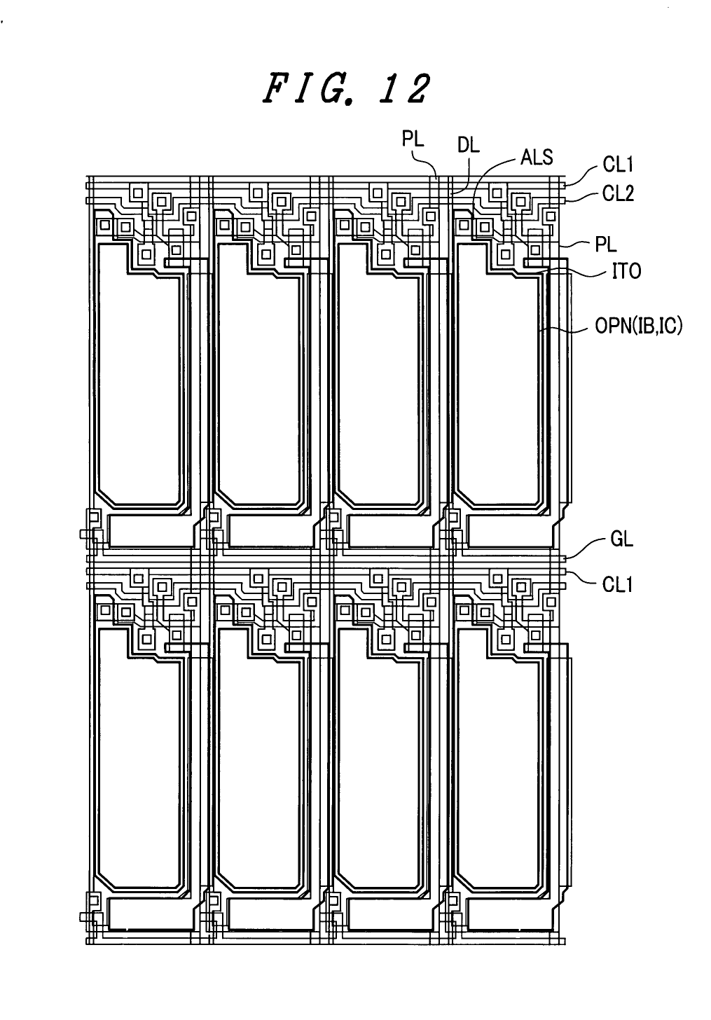

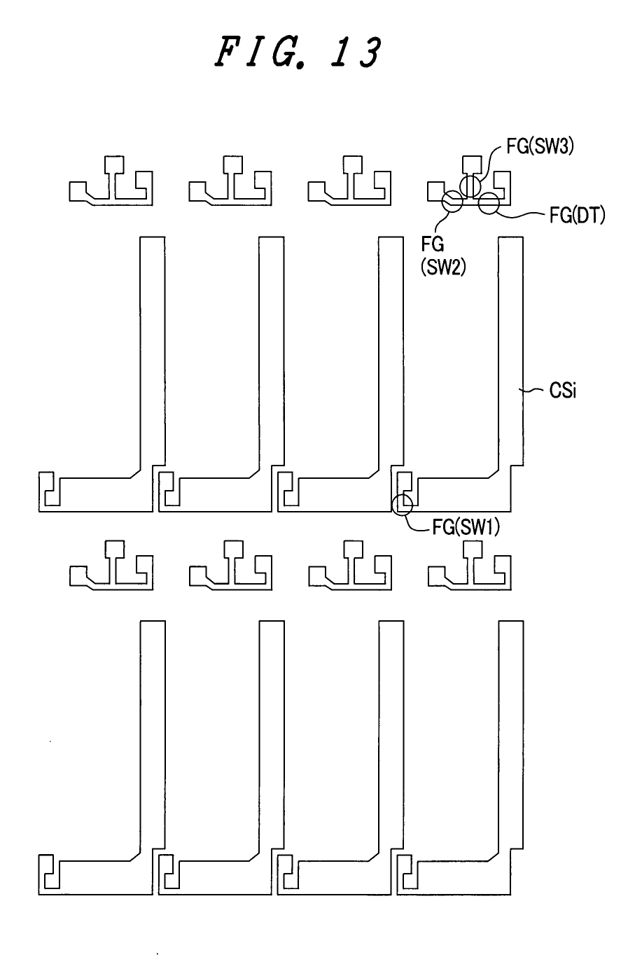

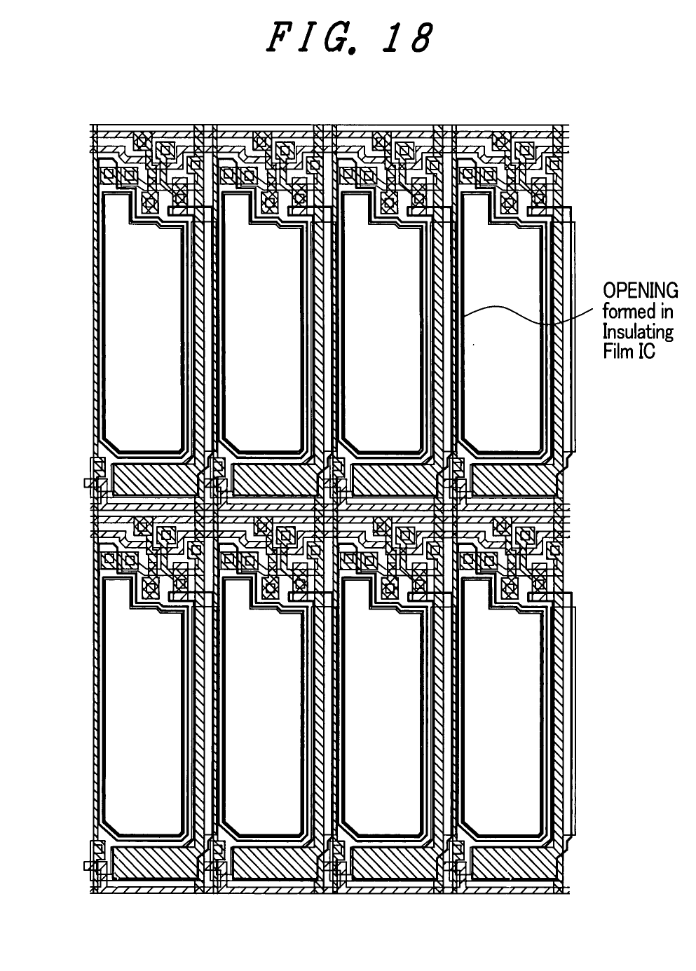

FIG. 13 to FIG. 18 are plan views similar to FIG. 12, wherein the manufacturing steps of another embodiment of the organic EL light emitting display device which adopts the present invention as sequentially illustrated. Further, FIGS. 19A-19H are cross-sectional views showing the manufacturing steps of another embodiment of the organic EL light emitting display device which adopts the present invention. In this embodiment, the bank is formed of insulation layers IB and IC made of an inorganic material. In each of FIGS. 19A-19H, a silicon nitride SiN film and a silicon oxide SiO₂ film are formed on the main surface of the substrate SUB and a first gate FG is patterned on the silicon nitride SiN film and the silicon oxide SiO₂ film (FIG. 19A). The pattern of the first gate FG is shown in FIG. 13. Next, on the first gate FG, the gate insulation film GI is formed and the second gate SG is patterned on the first gate FG in the active element forming region (FIG. 19B). The pattern of the second gate SG is shown in FIG. 14.

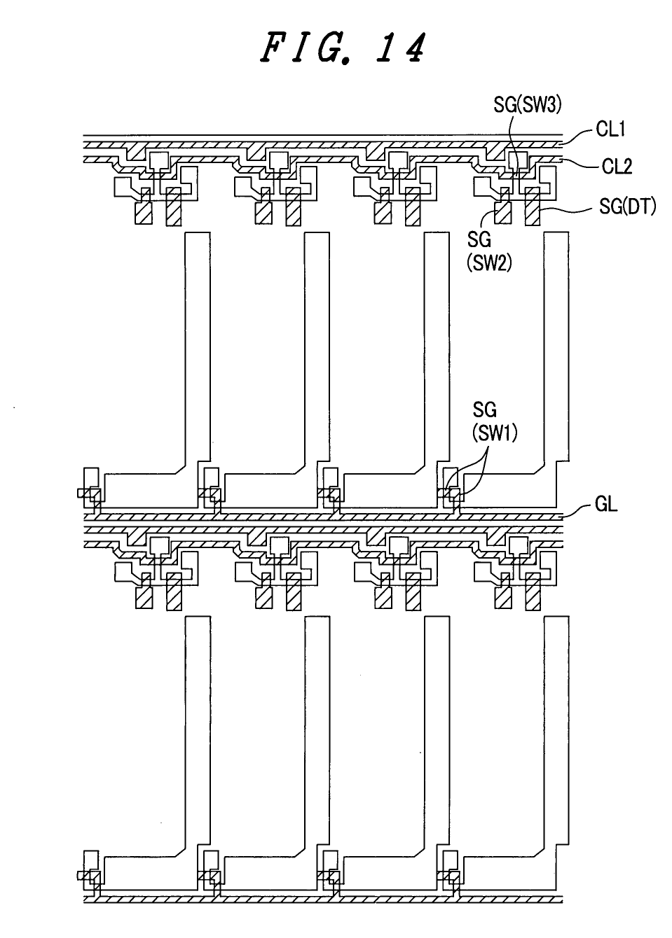

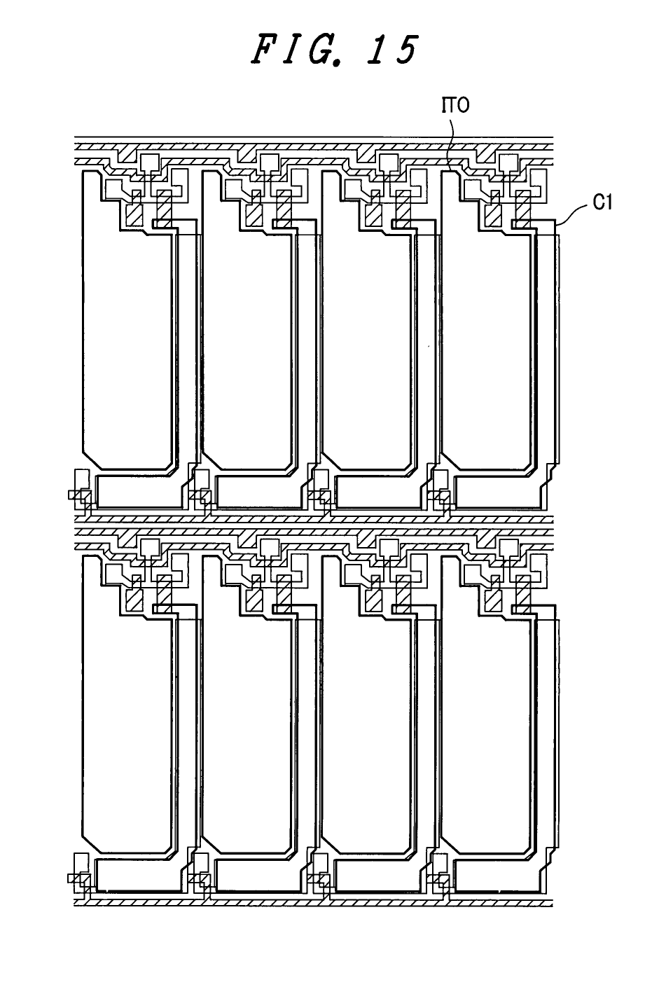

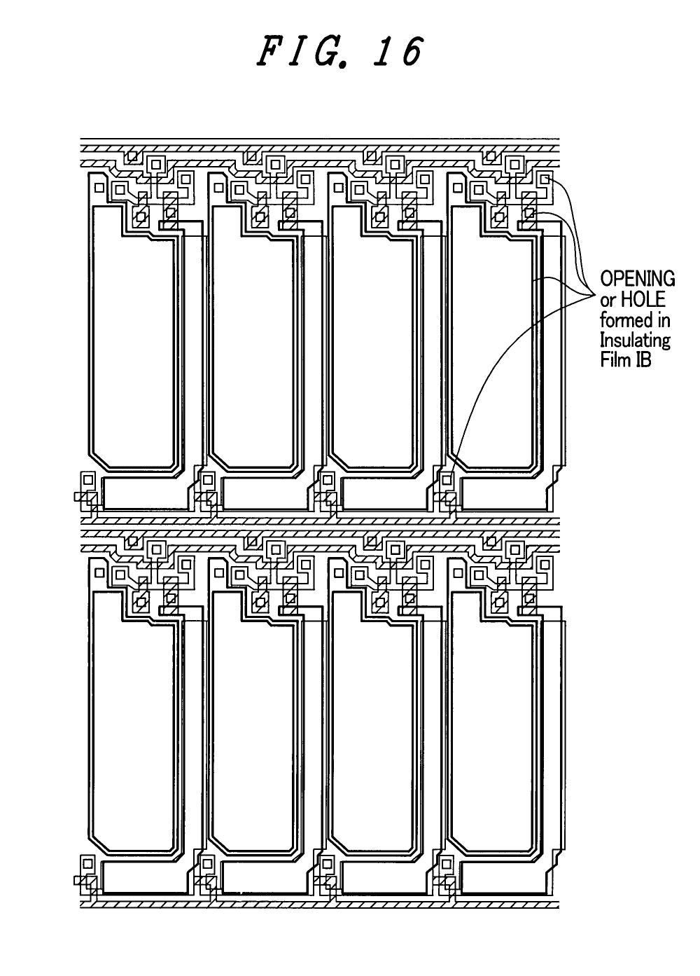

Next, on the first gate FG other than the light emitting area and the active element forming region, a transparent conductive film ITO is formed (FIG. 19C). The pattern of the transparent conductive film ITO is shown in FIG. 15. The insulation layer IB is patterned on the portion except for the light emitting area. On the insulation layer IB, a line AL which connects between switches and also forms a drain electrode of the active element and a line ALS which connects between switches and also forms a shielding member are patterned (FIG. 19D). The line AL which connects between the switching elements and the line ALS which connects between switches and constitutes the shielding member are connected to the first gate FG via the contact hole. The positions where the contact holes are formed are shown in FIG. 16 and the patterns of the line AL which connects between the switches and of the line ALS which connects between the switches and constitutes the shielding member ALS are shown in FIG. 17.

After forming the line AL which connects between switches and the line ALS which connects between switches and constitutes the shielding member, an insulation layer IC is formed (FIG. 19E). This insulation layer IC is formed in a bank shape which has an opening in the light emitting area and exposes the transparent conductive film ITO. On the whole surfaces of the insulation layer IC and the transparent conductive film ITO, a hole transporting layer HTL is formed (FIG. 19F) and an organic light emitting layer OCT is formed in the inside of the bank formed of the insulation layer IC (FIG. 19G). The pattern of the organic light emitting layer OCT is shown in FIG. 18. Thereafter, the whole surface of the organic light emitting layer OCT is covered with another electrode (the cathode electrode) CM (FIG. 19H).

In the organic EL light emitting display device according to this embodiment, in the same manner as the above-mentioned embodiment, by forming the bank which is arranged between the neighboring pixels using an inorganic material and setting the thickness of the bank to be smaller than the thickness of the electrode above the bank, edge growth is not generated, and, hence, a lowering of the numerical aperture is prevented. Further, the lowering of the brightness attributed to the reflection of stray light emitted from the neighboring pixels on the slope of the bank can be also suppressed. Further, the generation of short-circuiting between the electrodes which sandwich the organic EL layer therebetween is prevented.

FIG. 20 is a cross-sectional view showing the constitution of the vicinity of one pixel of still another example of the further organic EL light emitting display device which adopts the present invention. The constitution which makes the organic EL light emitting display device shown in FIG. 20 different from the organic EL light emitting display devices shown in FIG. 1 and FIG. 11 lies in the fact that the structure of the active element is set upside down from the above-mentioned constitution and has no such bank-like bank structure as described in the above-mentioned embodiments. The reference symbols equal to those used in the above-mentioned respective embodiments identify identical functional parts. In this organic EL light emitting display device, a multi-layered structure which forms a structural body constitute active elements and light emitting areas are adhered to the main surface of the substrate SUB using an adhesive layer GRU.

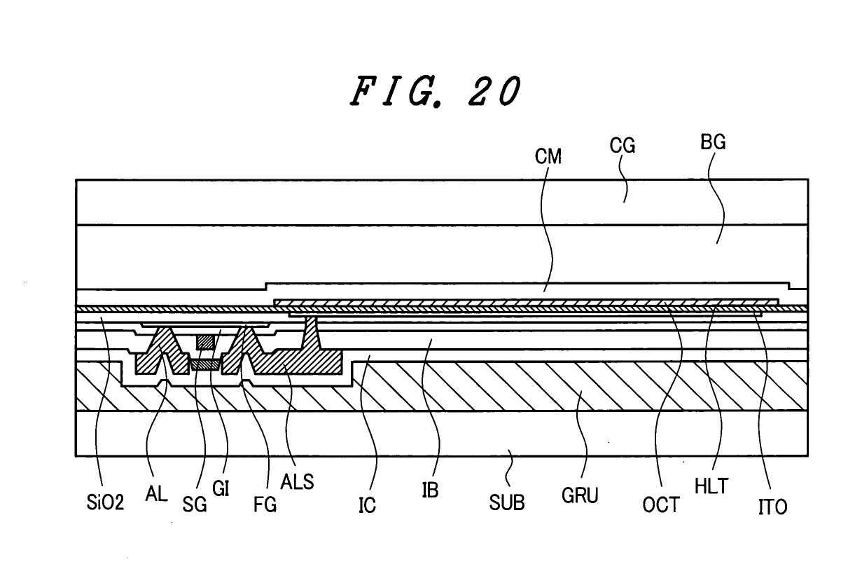

FIGS. 21A-21I are cross-sectional views showing the manufacturing steps in the fabrication of the organic EL light emitting display device shown in FIG. 20. First of all, a transparent conductive film ITO which forms one electrode (an anode electrode) is formed on the temporary substrate ASUB (FIG. 21A). On the transparent conductive film ITO, an inorganic material insulation layer SiO₂ is formed (FIG. 21B). On the insulation layer SiO₂, a first gate FG is patterned and the first gate FG is covered with a gate insulation layer GI. Further, a second gate SG is patterned onto the gate insulation layer GI (FIG. 21C). On the second gate SG, an insulation layer IB which is formed of an inorganic material is formed (FIG. 21D). A contact hole is formed in the insulation layer IB and a line AL which connects between switches and a line ALS which connects between switches and also constitutes a shielding member are formed (FIG. 21E). On the line AL which connects between switches and the line ALS which connects between switches and also constitutes the shielding member ALS, an insulation layer IC which is formed of an inorganic material is formed (FIG. 21F).

To an upper surface of the insulation layer IC, using an adhesive agent GRU, the substrate SUB which is favorably formed of a transparent glass is adhered (FIG. 21G). In this state, the organic light emitting layer has not been formed yet. Next, the temporary substrate ASUB is peeled off so as to expose the transparent conductive film ITO (FIG. 21H).

Thereafter, on the transparent conductive film ITO, a hole transporting layer HTL, an organic light emitting layer OCT, and an other electrode (cathode electrode) CM are formed (FIG. 21I).

Since the organic EL light emitting display device according to this embodiment has no so-called bank, there is no possibility that moisture or oxygen intrudes into the organic light emitting layer and causes the deterioration of the organic light emitting layer. The deterioration of the brightness attributed to the lowering of the numerical aperture is obviated. Further, the intrusion of stray light from the neighboring pixels can be prevented. Further, there is no stepped portions around the pixel area, and, hence, the generation of so-called broken steps is avoided and short-circuiting between one electrode ITO and another electrode CM can be prevented.

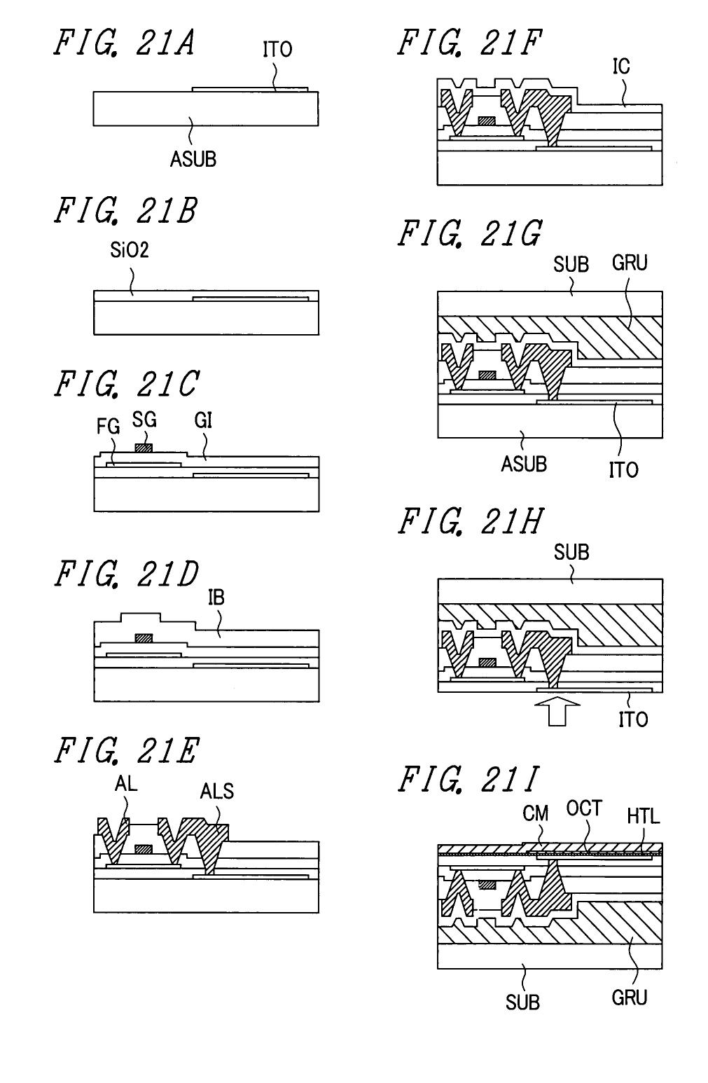

FIG. 22 is a diagram of a circuit constitution of the organic EL light emitting display device which adopts the present invention. The organic EL light emitting display device according to the present invention is constituted by arranging a data driving circuit DDR, a scanning driving circuit DDG, a current supply circuit PW around a display portion DIP (a region surrounded by a dotted line in FIG. 22) which is formed of a matrix array of a plurality of drain lines DL and a plurality of scanning signal lines (gate lines) GL on the substrate SUB.

The data driving circuit DDR includes a complementary circuit which is provided with a TFT (thin film transistor) having an N type channel and a TFT which is provided with a P type channel, or a shift register circuit which is provided with only a TFT having an N type channel or only a TFT having an P type channel, a level shifter circuit, an analogue switch circuit and the like. In the pixel PX surrounded by the data lines DL and the gate lines DL, a switching element (control transistor) SW1, a current supply transistor (drive transistor) DT, a capacitor C and an organic EL element OCT are arranged. The control electrode (gate) of the switching element SW1 is connected to the gate line GL, while one end (drain) of the channel is connected to the data line DL. The gate of the current supply transistor DT is connected to the other end (source) of the channel of the switching element SW1 and, to the connection point, the other electrode (+pole) of the capacitor C is connected. One end (drain) of the channel of the current supply transistor DT is connected to the current supply line PL and the other end (source) is connected to the anode of the organic EL element LED. The data line DL is driven by the data driving circuit DDR and the scanning line (gate line) GL is driven by the scanning driving circuit DDG. Further, the current supply line PL is connected to the current supply circuit PW via the common potential supply bus line PLA.

In FIG. 22, when one pixel PX is selected in the scanning line GL and the switching element (control transistor) SW1 thereof is turned on, an image signal supplied from the data line DL is stored in the capacitor C. Thereafter, when the switching element SW1 is turned off, the current supply transistor DT is turned on and the current flows from the current supply line PL to the organic EL element LED for approximately one frame period. The current which flows in the organic EL element LED is controlled by the current supply transistor DT and, further, to the gate of the current supply transistor DT, the voltage corresponding to the charge stored in the capacitor C is applied. Accordingly, the light emitting of the pixel is controlled. Although not shown in FIG. 22, the operating level of the capacitor C may be controlled by the potentials of the control signal lines CL1, CL2 shown in FIG. 3A.

In the pixel structure shown in FIG. 3A, since the control signal lines CL1, CL2 are formed such that control signal lines CL1, CL2 penetrate portions of the pixel region, the area of the light emitting region is limited. However, by controlling the operation of a plurality of current supply transistors DT which are arranged within the display screen by the control signal lines CL1, CL2, it is possible to obtain an advantageous effect in that an image can be generated on the display screen without being influenced by the irregularities of characteristics of these parts.

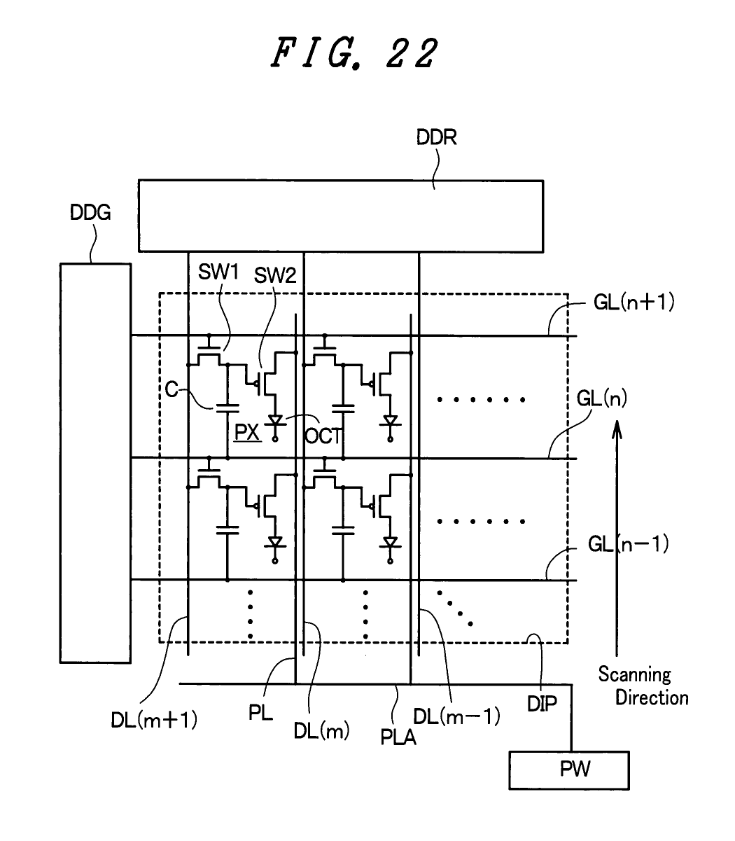

FIG. 23 is a plan view showing the arrangement on the substrate of a product example of the organic EL light emitting display device according to the present invention. The reference symbols equal to those used in FIG. 22 identify identical functional parts. Most of the center of the substrate SUB is occupied by a display region AR which is constituted of a matrix array AMX of a pixel circuit and an organic light emitting layer (not shown in the drawing). Outside this display region AR, the data driving circuit DDR, the scanning driving circuit DDG and the current supply circuit PW are arranged. A sealing agent is applied to these respective circuits and an outmost periphery of the display region AR by coating, and a cover glass to be described later is laminated to the assembled body. Here, the data driving circuit DDR, the scanning driving circuit DDG and the current supply circuit PW are connected to the external circuits using pads PAD formed on one side of the substrate SUB.

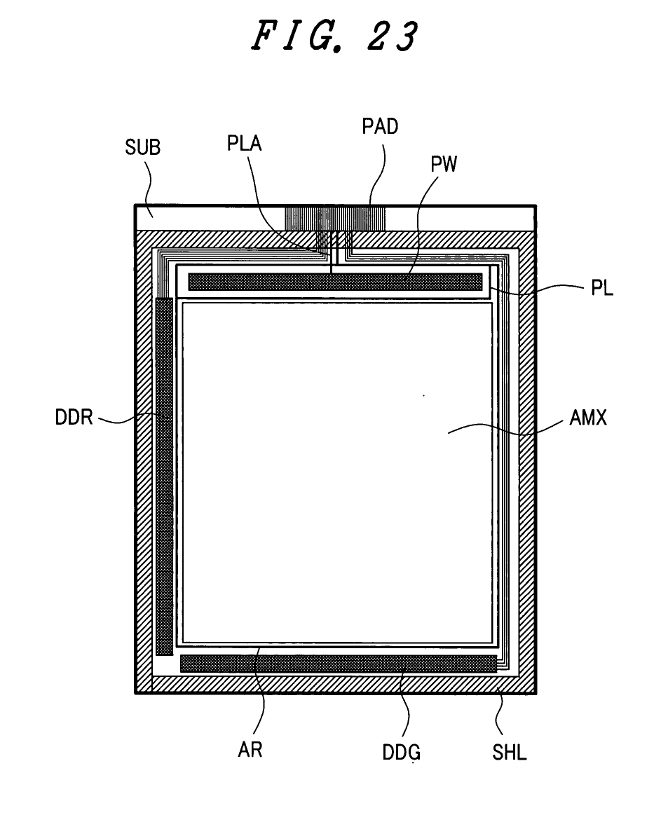

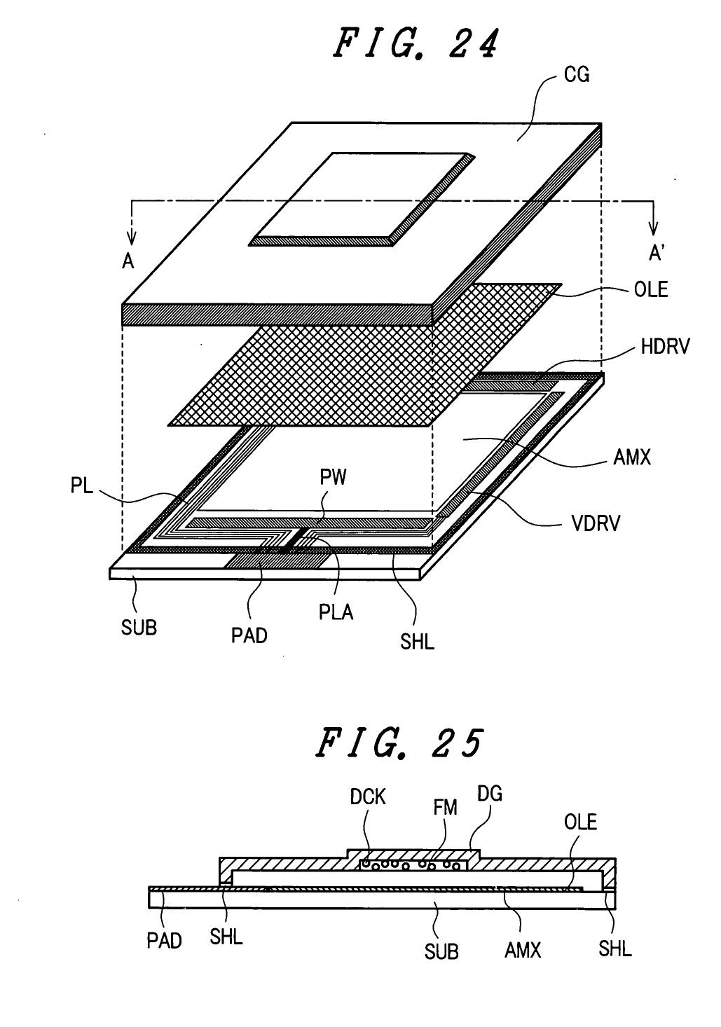

FIG. 24 is a developed perspective view showing the whole constitution of the product example of the organic EL light emitting display device according to the present invention and FIG. 25 is a cross-sectional view taken along a line A-A′ in FIG. 24. The constitution of the substrate shown in FIG. 24 and FIG. 25 is exactly equal to the constitution explained in conjunction with FIG. 23. Here, for facilitating the explanation, the organic light emitting layer OLE is shown separately from the matrix array AMX of the pixel circuit. However, it is needless to say that the matrix array AMX of the pixel circuit and the organic light emitting layer OLE are integrally formed as described above. A cover glass CG has an outer periphery thereof adhered to the substrate SUB using a sealing agent SHL. In this constitutional example, a recessed portion is formed in an inner surface of the cover glass CG and a drying agent (a moisture absorbent DCK) is stored and is covered with a film.

The organic EL light emitting display device according to the present invention emits light with a brightness which is substantially proportional to the amount of current supplied to the organic EL light emitting display device and with a color corresponding to the organic light emitting material (electroluminescence material) which forms the light emitting layer provided to the organic light emitting element. In the organic EL light emitting display device which can produce a color display, in many cases, the organic light emitting layer materials which are used for the light emitting layers are changed for respective pixels for red, green, blue. Further, there also exists a case in which the color display is produced by the organic EL light emitting display device which forms the light emitting layers of respective pixels using an organic light emitting layer material which radiates a so-called white light and combines color filters used in a liquid crystal display device with these light emitting layers.

Here, in any one of the above-mentioned organic EL light emitting display devices, the video signals (data signals) can be transmitted in a form of either analogue quantity or time division digital quantity. Further, an area grayscale method which divides a light emitting area to light emitting areas of respective pixels of red, green, blue may be combined with a gray scale control of the organic EL light emitting display device.

As has been explained heretofore, according to the present invention, in the organic EL light emitting display device which produces an image display by active matrix driving (TFT driving), the degradation of the image quality and the generation of smears can be prevented. Further, the contrast ratio and the brightness of the display image is enhanced. Accordingly, it is possible to obtain an organic EL light emitting display device which can produce a high-quality image display.

What we claim is:

1. An organic EL light emitting display device comprising:
a matrix array including a plurality of pixel circuits, each including an organic light emitting element;
a scan driving circuit coupled to said pixel circuits;
a current supply circuit coupled to said pixel circuits; and
a plurality of pads adapted to connect the scan driving circuit and the current supply circuit to external circuits,
wherein the pads are located to be closer to the current supply circuit than to the scan driving circuit.

2. An organic EL light emitting display device comprising:
a matrix array including a plurality of pixel circuits, each including an organic light emitting element;
a scan driving circuit coupled to said pixel circuits;
a current supply circuit coupled to said pixel circuits; and
a plurality of pads adapted to connect the scan driving circuit and the current supply circuit to external circuits,
wherein an order of arrangement is provided as follows:
the pads;
the matrix array; and
the scan driving circuit.

3. An organic EL light emitting display device comprising:
a matrix array including a plurality of pixel circuits, each including an organic light emitting element;
a scan driving circuit coupled to said pixel circuits;
a current supply circuit coupled to said pixel circuits; and
a plurality of pads adapted to connect the scan driving circuit and the current supply circuit to external circuits,
wherein the pads and the scan driving circuit are located on opposite sides of the matrix array.

4. An organic EL light emitting display device according to claim 2,
wherein the current supply circuit and the pads are located on the same edge of the matrix array.

5. An organic EL light emitting display device according to claim 3,
wherein the current supply circuit and the pads are located on the same edge of the matrix array.

6. The organic EL light emitting display device according to claim 1, further comprising a data driving circuit located on an edge of the matrix array which is adjacent to an edge on which the pads are located.

7. The organic EL light emitting display device according to claim 2, further comprising a data driving circuit located on an edge of the matrix array which is adjacent to an edge on which the pads are located.

8. The organic EL light emitting display device according to claim 3, further comprising a data driving circuit located on an edge of the matrix array which is adjacent to an edge on which the pads are located.

9. The organic EL light emitting display device according to claim 1, further comprising a common potential supply bus line adapted to connect the current supply circuit to the pads.

10. The organic EL light emitting display device according to claim 2, further comprising a common potential supply bus line adapted to connect the current supply circuit to the pads.

11. The organic EL light emitting display device according to claim 3, further comprising a common potential supply bus line adapted to connect the current supply circuit to the pads.
